(19) United States
(12) Patent Application Publication
(10) Pub. No.: US 2025/0219232 A1
(43) Pub. Date: Jul. 3, 2025

(54) ELECTRICAL APPARATUS AND CASE

(71) Applicant: MAKITA CORPORATION, Anjo-shi (JP)

(72) Inventor: Junya YAMAGUCHI, Anjo-shi (JP)

(73) Assignee: MAKITA CORPORATION, Anjo-shi (JP)

(21) Appl. No.: 18/975,188

(22) Filed: Dec. 10, 2024

(30) Foreign Application Priority Data
Dec. 27, 2023 (JP) 2023-221781

(51) Int. Cl. H01M 50/289; H01M 10/48; H01M 50/209; H01M 50/247; H01M 50/262; H01M 50/284

(52) U.S. Cl. CPC H01M 50/289; H01M 10/482; H01M 10/488; H01M 50/209; H01M 50/247; H01M 50/262; H01M 50/284; H01M 2220/30

(57) ABSTRACT

An electrical apparatus disclosed herein may include a first tray unit, a second tray unit, and a case body including a tray attachment portion configured to have selectively one of the first tray unit and the second tray unit attached thereto. The first tray unit may include a plurality of first battery attachment portions. The second tray unit may include a plurality of second battery attachment portions. An arrangement of the second battery attachment portions may be different from an arrangement of the first battery attachment portions, and/or a number of the second battery attachment portions may be different from a number of the first battery attachment portions, and/or an attachment structure of each of the second battery attachment portions for attaching the second battery may be different from an attachment structure of each of the first battery attachment portions for attaching the first battery.

### REFERENCE TO RELATED APPLICATIONS

This application claims priority from Japanese Patent Application No. 2023-221781 filed on Dec. 27, 2023. The entire content of the priority application is incorporated herein by reference.

### TECHNICAL FIELD

An art disclosed herein relates to an electrical apparatus and a case.

### BACKGROUND ART

Japanese Patent Application Publication No. 2016-62808 describes an electrical apparatus. The electrical apparatus includes a first tray unit and a case including a tray unit attachment portion configured to have the first tray unit attached thereto. The first tray unit includes a plurality of first battery attachment portions. Each of the first battery attachment portions is configured to have a first battery attached thereto.

### SUMMARY

In the above art, if a battery is not configured to be attached to the first battery attachment portion, another electrical apparatus to which the battery can be attached needs to be prepared. Due to this, improvement in convenience for a user (user convenience) is being desired. The present teachings provide an art which allows to improve user convenience.

An electrical apparatus disclosed herein may comprise a first tray unit, a second tray unit, and a case body including a tray attachment portion configured to have selectively one of the first tray unit and the second tray unit attached thereto. The first tray unit may comprise a plurality of first battery attachment portions, each of which is configured to have a first battery attached thereto, a first battery terminal configured to be electrically connected to the first battery when the first battery is attached to one of the first battery attachment portions, and a first case attachment portion configured to be attached to the tray attachment portion. The second tray unit may comprise a plurality of second battery attachment portions, each of which is configured to have a second battery attached thereto, a second battery terminal configured to be electrically connected to the second battery when the second battery is attached to one of the second battery attachment portions, and a second case attachment portion configured to be attached to the tray attachment portion. An arrangement of the plurality of second battery attachment portions may be different from an arrangement of the plurality of first battery attachment portions, and/or a number of the plurality of second battery attachment portions may be different from a number of the plurality of first battery attachment portions, and/or an attachment structure of each of the second battery attachment portions for attaching the second battery may be different from an attachment structure of each of the first battery attachment portions for attaching the first battery.

According to the above configuration, the first battery can be attached to each of the first battery attachment portions in the first tray unit. Also, the second battery can be attached to each of the second battery attachment portions in the second tray unit. Due to this, by switching between the first tray unit and the second tray unit, both of the first battery and the second battery can be used in a single electrical apparatus. Due to this, user convenience can be improved.

A case disclosed herein may comprise a first tray unit, a second tray unit, and a case body including a tray attachment portion configured to have selectively one of the first tray unit and the second tray unit attached thereto. The first tray unit may comprise a plurality of first battery attachment portions, each of which is configured to have a first battery attached thereto and a first case attachment portion configured to be attached to the tray attachment portion. The second tray unit may comprise a plurality of second battery attachment portions, each of which is configured to have a second battery attached thereto and a second case attachment portion configured to be attached to the tray attachment portion. The case body may be configured to accommodate the first battery and the second battery. An arrangement of the plurality of second battery attachment portions may be different from an arrangement of the plurality of first battery attachment portions, and/or a number of the plurality of second battery attachment portions may be different from a number of the plurality of first battery attachment portions, and/or an attachment structure of each of the second battery attachment portions for attaching the second battery may be different from an attachment structure of each of the first battery attachment portions for attaching the first battery.

According to the above configuration, the first battery can be attached to one of the first battery attachment portions in the first tray unit. Also, the second battery can be attached to one of the second battery attachment portions in the second tray unit. Due to this, by switching between the first tray unit and the second tray unit, both of the first battery and the second battery can be used in a single case. Due to this, user convenience can be improved.

### BRIEF DESCRIPTION OF DRAWINGS

FIG. 1 illustrates a perspective view of an electrical apparatus 2 of a first embodiment, with a lid 6 open.

FIG. 2 illustrates a perspective view of the electrical apparatus 2 of the first embodiment, with the lid 6 removed.

FIG. 3 illustrates a perspective view of the electrical apparatus 2 of the first embodiment, with the lid 6 removed and without battery packs BP.

FIG. 4 illustrates a perspective view of a case body 4 of the first embodiment.

FIG. 5 illustrates a top view of the case body 4 of the first embodiment.

FIG. 6 illustrates an enlarged cross-sectional view of a front and lower part of the electrical apparatus 2 of the first embodiment.

FIG. 7 illustrates a perspective view of the electrical apparatus 2 of the first embodiment, with the lid 6 closed.

FIG. 8 illustrates a perspective view of the electrical apparatus 2 of the first embodiment, with the lid 6 removed and without battery packs BP.

FIG. 9 illustrates a perspective view of a first tray unit 30 and control boards 34 of the first embodiment.

FIG. 10 illustrates a perspective view of the first tray unit 30 of the first embodiment.

FIG. 11 illustrates a bottom view of the first tray unit 30 and a second tray unit 32 of the first embodiment.

FIG. 12 illustrates an exploded perspective view of the case body 4 and the first tray unit 30 of the first embodiment.

FIG. 13 illustrates a perspective view of the first tray unit 30 and the control boards 34 of the first embodiment.

FIG. 14 illustrates an enlarged cross-sectional view of a left and upper part of the electrical apparatus 2 of the first embodiment.

FIG. 15 illustrates a perspective view of a first battery pack BP1 of the first embodiment.

FIG. 16 illustrates a perspective view of a second tray unit 32 and the control boards 34 of the first embodiment.

FIG. 17 illustrates a perspective view of the second tray unit 32 of the first embodiment.

FIG. 18 illustrates a perspective view of the second tray unit 32 and the control boards 34 of the first embodiment.

FIG. 19 illustrates an enlarged cross-sectional view of a left upper part of the electrical apparatus 2 of the first embodiment.

FIG. 20 illustrates a perspective view of a second battery pack BP2 of the first embodiment.

FIG. 21 illustrates a perspective view of the electrical apparatus 2 of the first embodiment in which a third battery pack BP3 is attached to a second battery attachment portion 142 via an adapter 152.

FIG. 22 illustrates a top view of the electrical apparatus 2 of the first embodiment, seeing a first battery status indicator 160 and its vicinity.

FIG. 23 illustrates a side view of a front battery terminal board 174, a rear battery terminal board 176, and a lens 184 of the first embodiment.

FIG. 24 illustrates a perspective view of the lens 184 of the first embodiment.

FIG. 25 illustrates an enlarged cross-sectional view of the electrical apparatus 2 of the first embodiment, seeing the lens 184 and its vicinity.

FIG. 26 illustrates a cross-sectional view of the lens 184 and a second engagement rib 252 of the first embodiment.

FIG. 27 illustrates a cross-sectional view of the lens 184 and the second engagement rib 252 of the first embodiment.

FIG. 28 illustrates a side view of the front battery terminal board 174 and the lens 184 of the first embodiment, seeing a front light emitting device 258 and its vicinity.

FIG. 29 illustrates a side view of the rear battery terminal board 176 and the lens 184 of the first embodiment, seeing a rear light emitting device 260 and its vicinity.

FIG. 30 illustrates an electrical apparatus 2 of a second embodiment, in which a tool 360 is accommodated in a case body 4.

FIG. 31 illustrates a perspective view of an electrical apparatus 2 of a third embodiment, with a lid 6 removed.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved electrical apparatuses and cases as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

An electrical apparatus disclosed herein may comprise a first tray unit, a second tray unit, and a case body including a tray attachment portion configured to have selectively one of the first tray unit and the second tray unit attached thereto. The first tray unit may comprise a plurality of first battery attachment portions, each of which is configured to have a first battery attached thereto, a first battery terminal configured to be electrically connected to the first battery when the first battery is attached to one of the first battery attachment portions, and a first case attachment portion configured to be attached to the tray attachment portion. The second tray unit may comprise a plurality of second battery attachment portions, each of which is configured to have a second battery attached thereto, a second battery terminal configured to be electrically connected to the second battery when the second battery is attached to one of the second battery attachment portions, and a second case attachment portion configured to be attached to the tray attachment portion. An arrangement of the plurality of second battery attachment portions may be different from an arrangement of the plurality of first battery attachment portions, and/or a number of the plurality of second battery attachment portions may be different from a number of the plurality of first battery attachment portions, and/or an attachment structure of each of the second battery attachment portions for attaching the second battery may be different from an attachment structure of each of the first battery attachment portions for attaching the first battery.

In one or more embodiments, an attachment structure of the first case attachment portion for being attached to the tray attachment portion may be the same as an attachment structure of the second case attachment portion for being attached to the tray attachment portion.

According to the above configuration, the structure of the tray attachment portion can be suppressed from becoming complicated as compared to a configuration in which the attachment structure of the first case attachment portion for being attached to the tray attachment portion is different from the attachment structure of the second case attachment portion for being attached to the tray attachment portion.

In one or more embodiments, the attachment structure of each of the first battery attachment portions for attaching the first battery may be the same as the attachment structure of each of the second battery attachment portions for attaching the second battery.

According to the above configuration, the first battery can be attached to each of the second battery attachment portions, and the second battery can be attached to each of the first battery attachment portions. Due to this, user convenience can be improved.

In one or more embodiments, the electrical apparatus may further comprise a control board attached to the first tray unit.

According to the above configuration, after the control board is attached to the first tray unit, the first tray unit can be attached to the case body. Due to this, assembly of the electrical apparatus can be facilitated.

In one or more embodiments, the control board may be configured to be attached to the second tray unit.

According to the above configuration, a control board dedicated for the second tray unit is unnecessary. Due to this, the number of parts in the electrical apparatus can be reduced.

In one or more embodiments, the first tray unit may be attached to the tray attachment portion by a fastener. The fastener may be attached to the first tray unit from outside of the case body.

According to the above configuration, the first tray unit can be attached to the tray attachment portion by the fastener being inserted into the case body from outside the case body. Due to this, assembly of the electrical apparatus can be facilitated.

In one or more embodiments, the case body may comprise an accommodating space configured to accommodate the first tray unit and the second tray unit.

According to the above configuration, the first and second tray units are protected by the case body, and thus the first tray unit and the second tray unit can be suppressed from being damaged/broken.

In one or more embodiments, the first tray unit may comprise at least one first battery attachment unit. Each of the at least one first battery attachment unit may comprise two or more first battery attachment portions. The second tray unit may comprise at least one second battery attachment unit. Each of the at least one second battery attachment unit may comprise two or more second battery attachment portions. A number of the two or more second battery attachment portions may be the same as a number of the two or more first battery attachment portions. A number of the at least one second battery attachment unit may be different from a number of the at least one first battery attachment unit.

According to the above configuration, the first tray unit and the second tray unit can be selectively used according to the number of batteries used.

In one or more embodiments, the at least one first battery attachment unit may comprise a plurality of the first battery attachment units aligned in a row. The at least one second battery attachment unit may comprise a plurality of the second battery attachment units aligned in a row. In two first battery attachment units adjacent to each other, the two or more first battery attachment portions in each of the two first battery attachment units may be directed in the same direction. In two second battery attachment units adjacent to each other, a direction in which the two or more second battery attachment portions in one of the two second battery attachment units are directed may be different from a direction in which the two or more second battery attachment portions in the other of the two second battery attachment units are directed.

According to the above configuration, the first tray unit and the second tray unit can be selectively used according to the number and/or size of batteries used.

In one or more embodiments, the first tray unit may comprise a first indicator configured to indicate a status of the first battery.

According to the above configuration, the status of the first battery can be easily acknowledged.

In one or more embodiments, the plurality of first battery attachment portions may be aligned in a first direction. With respect to the first direction, a position of a center of the first indicator in the first direction may be located between two first battery attachment portions adjacent to each other in the first direction.

According to the above configuration, the first indicator can be easily positioned relative to the two first battery attachment portions.

A case disclosed herein may comprise a first tray unit, a second tray unit, and a case body including a tray attachment portion configured to have selectively one of the first tray unit and the second tray unit attached thereto. The first tray unit may comprise a plurality of first battery attachment portions, each of which is configured to have a first battery attached thereto and a first case attachment portion configured to be attached to the tray attachment portion. The second tray unit may comprise a plurality of second battery attachment portions, each of which is configured to have a second battery attached thereto and a second case attachment portion configured to be attached to the tray attachment portion. The case body may be configured to accommodate the first battery and the second battery. An arrangement of the plurality of second battery attachment portions may be different from an arrangement of the plurality of first battery attachment portions, and/or a number of the plurality of second battery attachment portions may be different from a number of the plurality of first battery attachment portions, and/or an attachment structure of each of the second battery attachment portions for attaching the second battery may be different from an attachment structure of each of the first battery attachment portions for attaching the first battery.

In one or more embodiments, an attachment structure of the first case attachment portion for being attached to the tray attachment portion may be the same as an attachment structure of the second case attachment portion for being attached to the tray attachment portion.

According to the above configuration, the structure of the tray attachment portion can be suppressed from becoming complicated as compared to a configuration in which the attachment structure of the first case attachment portion for being attached to the tray attachment portion is different from the attachment structure of the second case attachment portion for being attached to the tray attachment portion.

In one or more embodiments, the attachment structure of each of the first battery attachment portions for attaching the first battery may be the same as the attachment structure of each of the second battery attachment portions for attaching the second battery.

According to the above configuration, the first battery can be attached to one of the second battery attachment portions, and the second battery can be attached to one of the first battery attachment portions. Due to this, user convenience can be improved.

In one or more embodiments, the case may be configured to accommodate a tool.

According to the above configuration, the first battery, the second battery, and the tool are accommodated in the case, user convenience can be further improved.

### First Embodiment

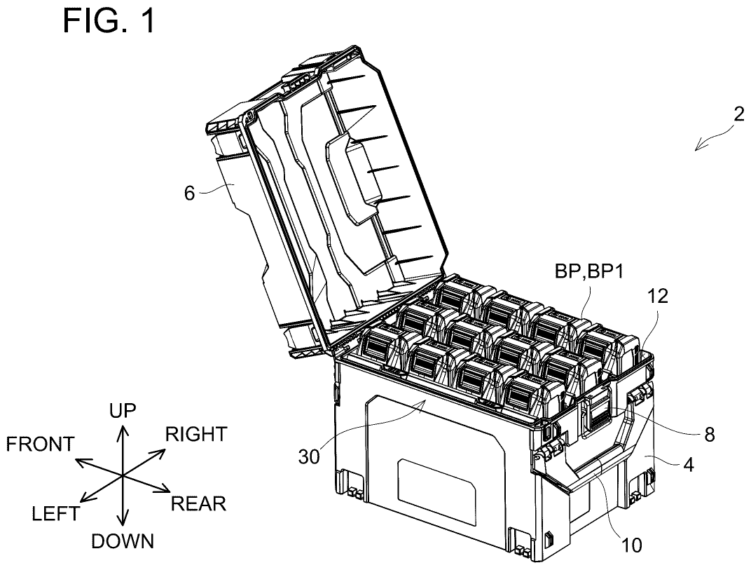

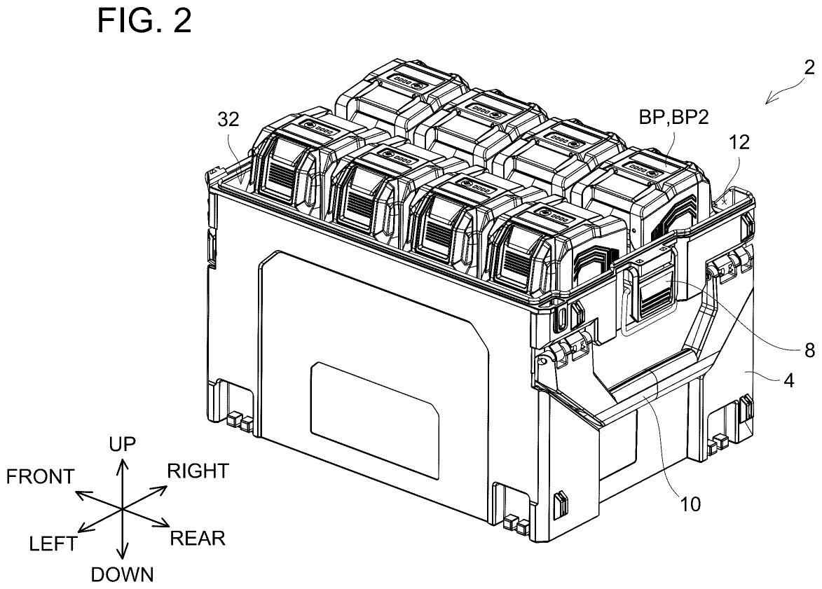

As shown in FIGS. 1 and 2, an electrical apparatus 2 is a charging apparatus configured to charge a first battery pack BP1 and also a second battery pack BP2 larger than the first battery pack BP1. Hereafter, the first battery pack BP1 and the second battery pack BP2 may each be referred simply as a battery pack BP. The battery pack BP is for example a rechargeable secondary battery. Also, the electrical apparatus 2 is a case which accommodates a plurality of battery packs BP. The electrical apparatus 2 has a substantially cuboid shape. As shown in FIG. 1, the electrical apparatus 2 comprises a case body 4, a lid 6, a latch 8, and a handle 10. Hereafter, a height direction of the electrical apparatus 2 will be referred to as an up-down direction, a direction perpendicular to the up-down direction will be referred to as a front-rear direction, and a direction perpendicular to the up-down and front-rear directions will be referred to as a left-right direction. In the present embodiment, the front-rear direction corresponds to a longitudinal direction of the electrical apparatus 2 and the left-right direction corresponds to a short direction of the electrical apparatus 2.

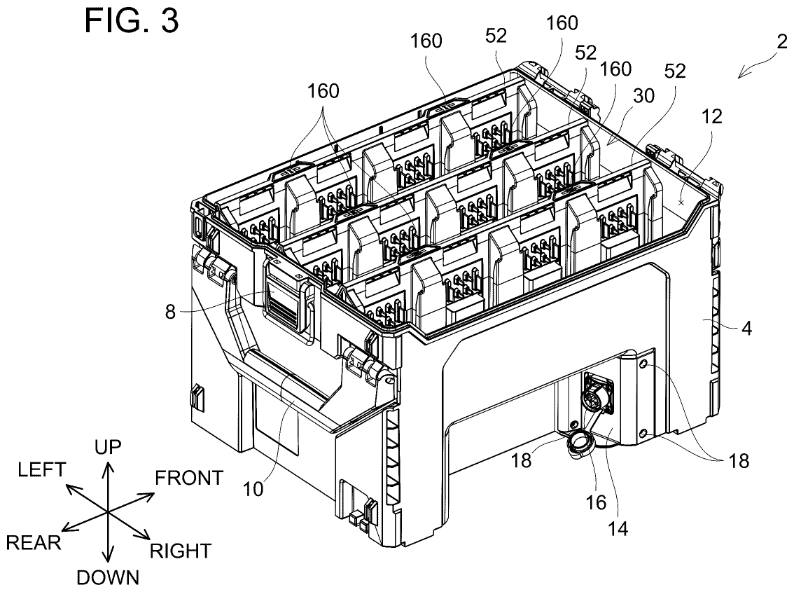

The case body 4 has a box shape having an open upper end. The case body 4 has an accommodating space 12 therein. The plurality of battery packs BP is arranged in the accommodating space 12. As shown in FIG. 3, a cable cover 14 is fixed to the case body 4 by a fastener 18. An exterior terminal 16 is fixed to the cable cover 14. Power is supplied from an exterior power supply (not illustrated) to the electrical apparatus 2 by a power adapter (not illustrated) being connected to the exterior terminal 16. The battery packs BP (see FIG. 1) are charged by the power supplied from the exterior power supply.

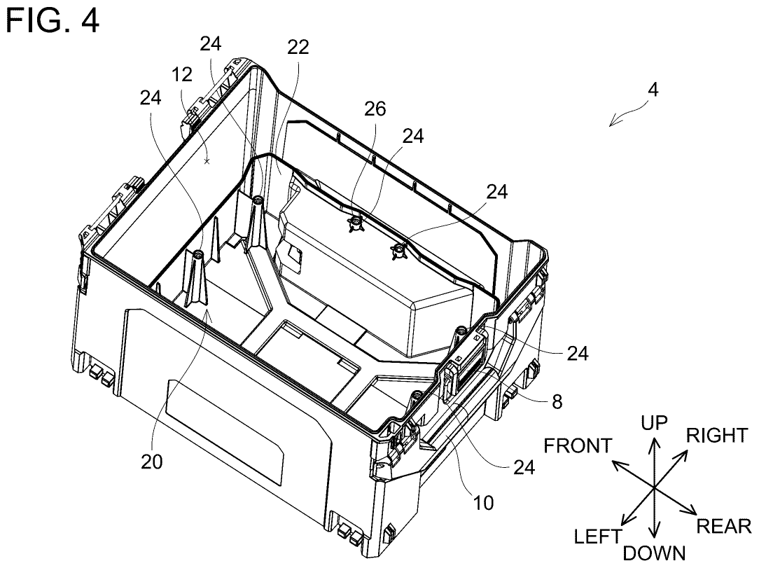

As shown in FIG. 4, the case body 4 comprises a tray attachment portion 20 and a peripheral wall 22.

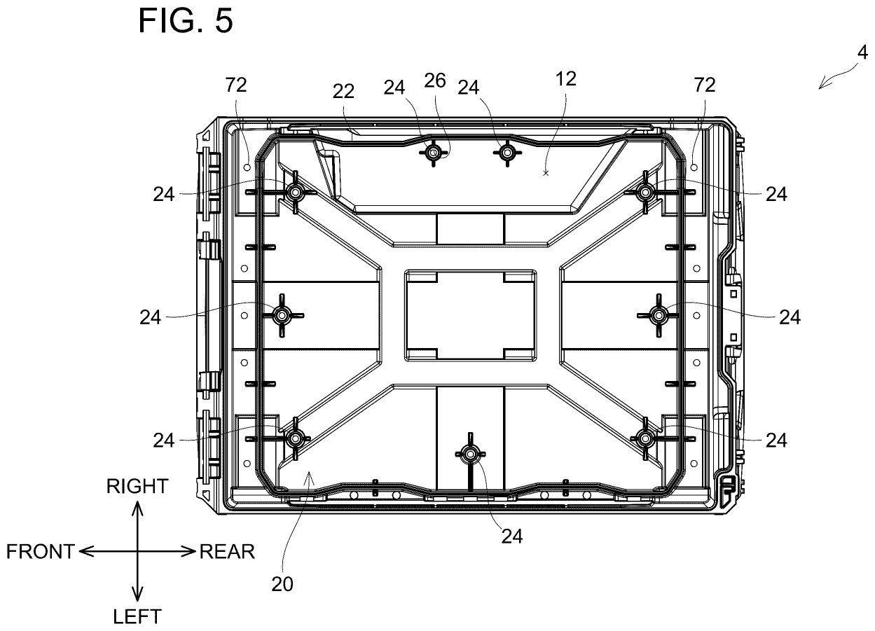

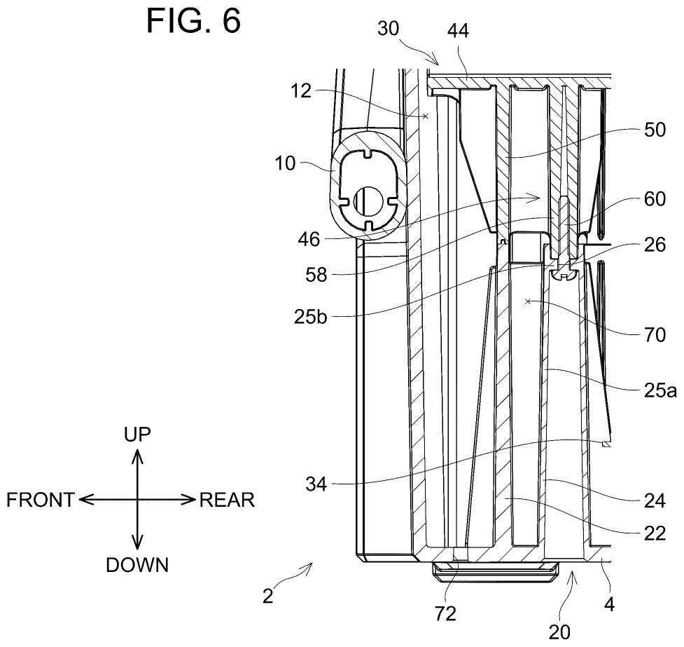

As shown in FIG. 5, the tray attachment portion 20 comprises a plurality of (nine in the present embodiment) projections 24. As shown in FIG. 6, the projections 24 project upward from an inner bottom surface of the case body 4. Each of the projections 24 comprises a cylindrical portion 25a having a substantially cylinder shape and a bottom wall 25b closing an upper end of the cylindrical portion 25a. Each of the projections 24 has a through hole 26 penetrating the bottom wall 25b of the projection 24.

The peripheral wall 22 projects upward from the inner bottom surface of the case body 4. The peripheral wall 22 surrounds the plurality of projections 24. The peripheral wall 22 extends along an inner side surface of the case body 4.

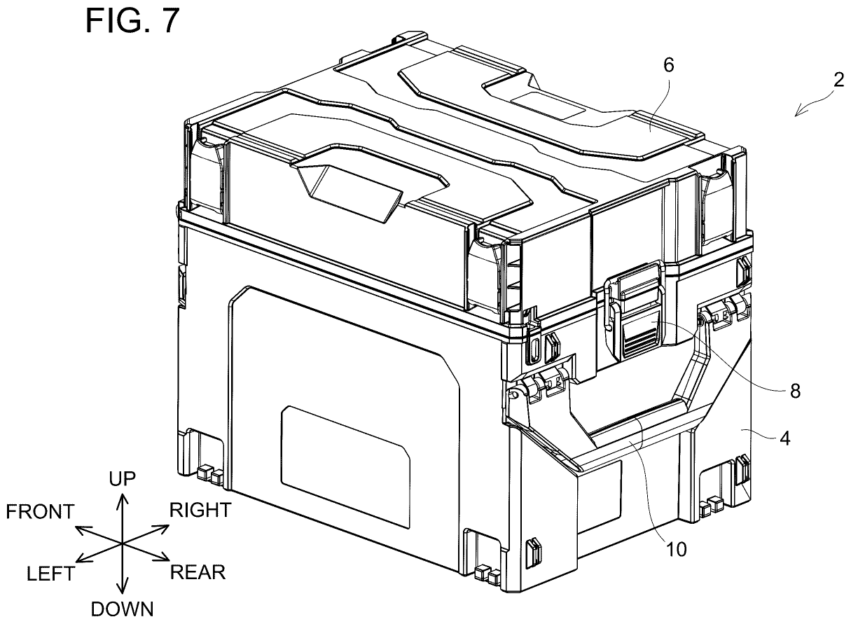

As shown in FIG. 1, the lid 6 is attached to the case body 4 such that the lid 6 is configured to open and close. When the lid 6 is open, a user can attach and detach the battery pack(s) BP. As shown in FIG. 7, the lid 6 is maintained in a state of being closed, by engaging with the latch 8.

The handle 10 is attached to an outer side surface of the case body 4. The user can carry around the electrical apparatus 2 by gripping the handle 10.

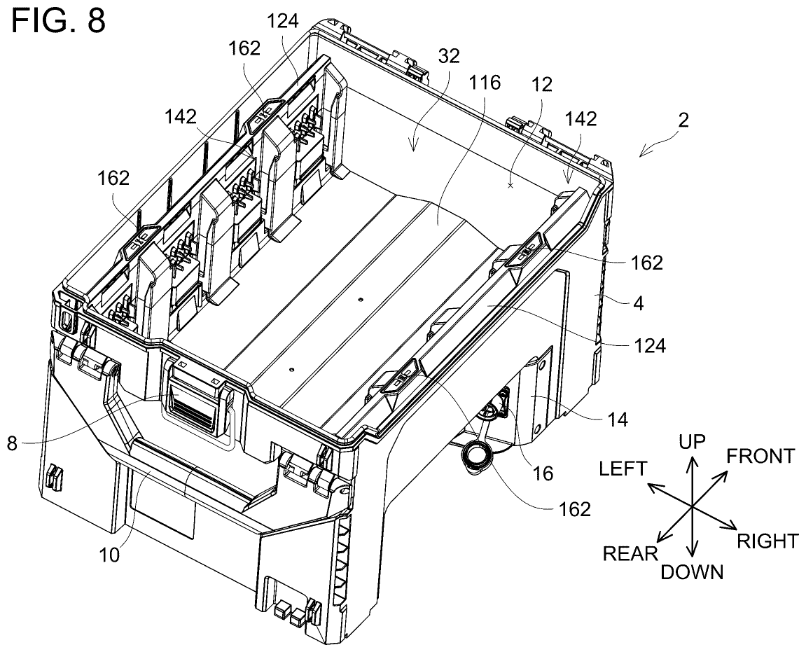

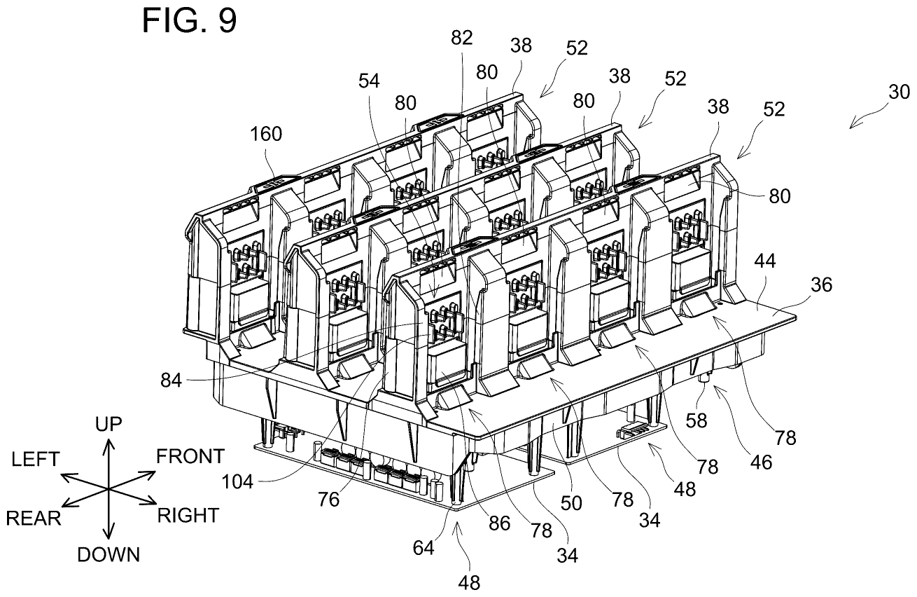

As shown in FIGS. 3 and 8, the electrical apparatus 2 comprises the first tray unit 30, a second tray unit 32, and one or more (two in the present embodiment) control boards 34 (see FIG. 9). One of the first tray unit 30 and the second tray unit 32 is selectively attached to the tray attachment portion 20 of the case body 4 (see FIG. 4). A shape of the first tray unit 30 differs from a shape of the second tray unit 32. As shown in FIG. 9, the two control boards 34 are selectively attached to one of the first tray unit 30 and the second tray unit 32 (see FIG. 8). The control boards 34 are electrically connected to the exterior terminal 16 (see FIG. 8). The control boards 34 control charging operation of the battery packs BP (see FIG. 1).

The first tray unit 30 comprises a first lower base member 36 and a plurality of (three in the present embodiment) first upper base members 38. The first lower base member 36 and the plurality of first upper base members 38 define an exterior shape of the first tray unit 30. The plurality of first upper base members 38 is secured to the first lower base member 36. The plurality of first upper base members 38 is arranged side-by-side in the left-right direction.

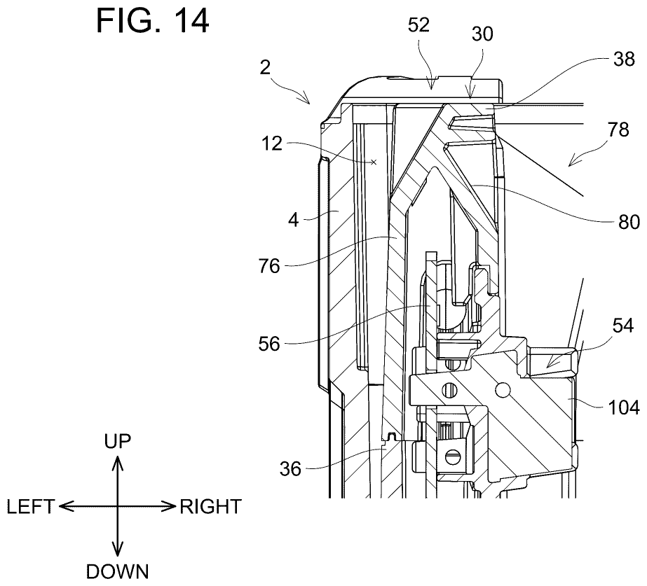

The first tray unit 30 comprises a first base plate portion 44, a first case attachment portion 46, two first board attachment portions 48, a first peripheral wall portion 50, at least one first battery attachment unit 52, a plurality of (twelve in the present embodiment) first battery terminal units 54, and a plurality of (twelve in the present embodiment) first battery terminal boards 56 (see FIG. 14). The first base plate portion 44, the first case attachment portion 46, the first board attachment portions 48, and the first peripheral wall portion 50 are configured by the first lower base member 36. The first battery attachment units 52 are configured by the first lower base member 36 and the first upper base members 38.

The first base plate portion 44 has a plate shape extending along the front-rear direction and the left-right direction.

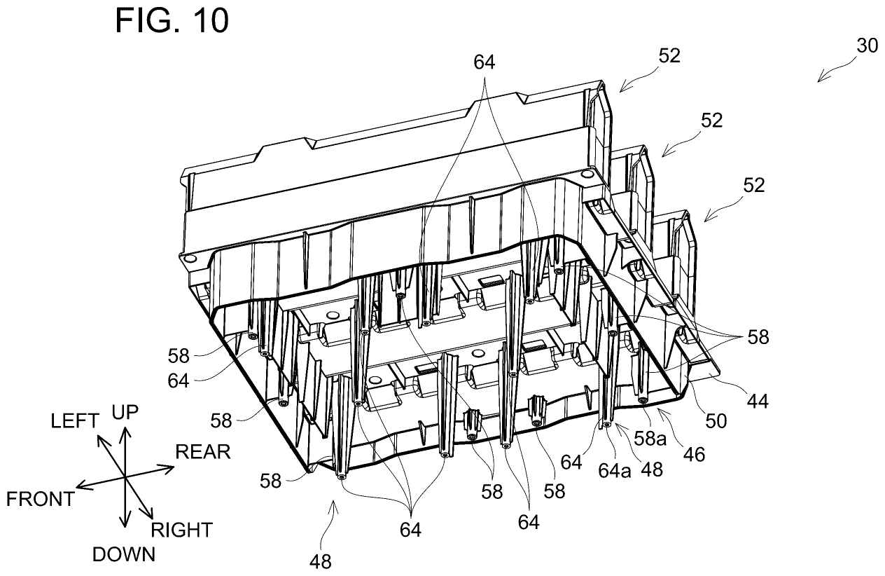

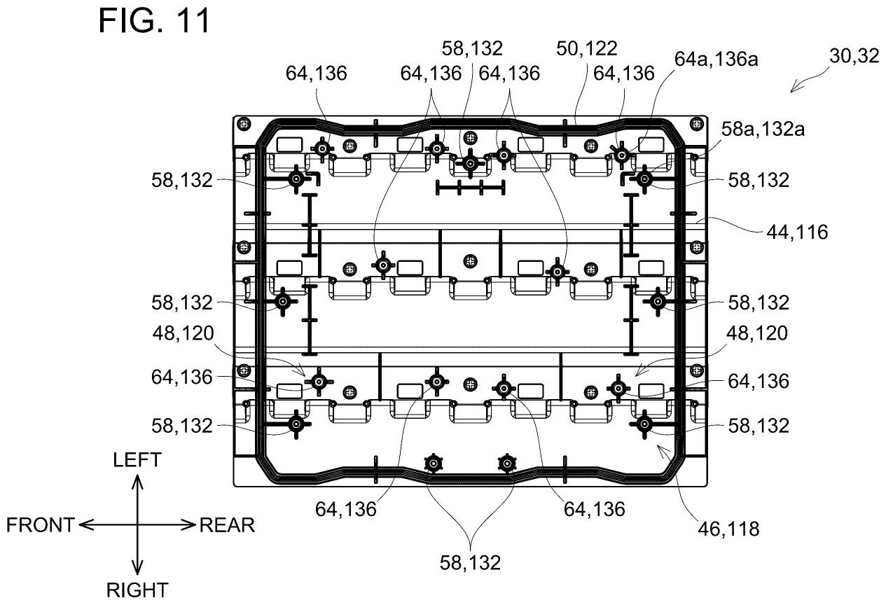

As shown in FIG. 10, the first case attachment portion 46 comprises a plurality of (nine in the present embodiment) first case attachment projections 58. The first case attachment projections 58 extend downward from a lower surface of the first base plate portion 44. The number of the plurality of first case attachment projections 58 is the same as the number of the plurality of projections 24 of the tray attachment portion 20 (see FIG. 5). As shown in FIG. 11, each of the first case attachment projections 58 has a first hole 58a. The first hole 58a has a thread defined therein. An arrangement of the first holes 58a of the plurality of first case attachment projections 58 is the same as an arrangement of the through holes 26 of the plurality of projections 24 shown in FIG. 5.

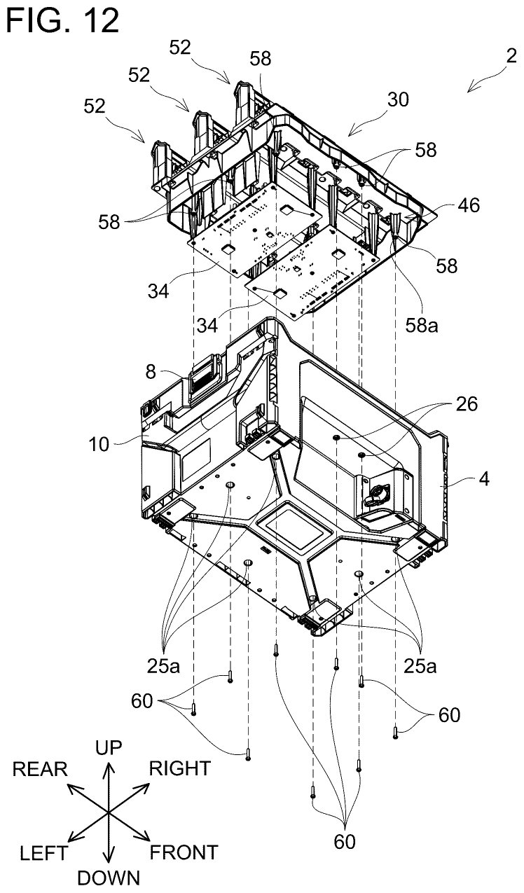

As shown in FIG. 12, when the first tray unit 30 is to be attached to the case body 4, firstly, the first holes 58a of the first case attachment projections 58 are caused to face the through holes 26 of the projections 24 (see FIG. 5). Next, fasteners 60 (e.g., screws) are inserted from outside the case body 4 into the cylindrical portions 25a of the projections 24. Next, after inserting the fasteners 60 into the through holes 26, the fasteners 60 are screwed with the threads of the first holes 58a. Due to this, the first tray unit 30 can be easily attached to the case body 4.

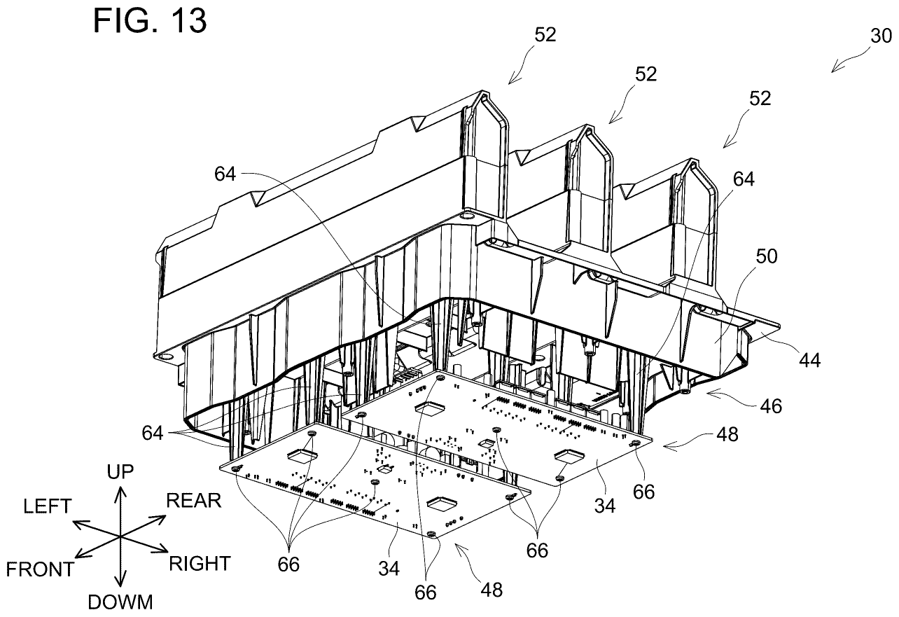

As shown in FIG. 10, the two first board attachment portions 48 are arranged side-by-side in the front-rear direction. Each of the first board attachment portions 48 comprises a plurality of (five in the present embodiment) first board attachment projections 64. The first board attachment projections 64 extend downward from the lower surface of the first base plate portion 44. As shown in FIG. 11, the first board attachment projections 64 have first holes 64a. Each of the first holes 64a has a thread defined therein. As shown in FIG. 13, by fasteners 66 (e.g., screws) being screwed with the first holes 64a (see FIG. 10), the control board 34 is attached to the five first board attachment projections 64. Due to this, one control board 34 is attached to one first board attachment portion 48. Due to this, the two control boards 34 are arranged side-by-side in the front-rear direction.

As shown in FIG. 10, the first peripheral wall portion 50 extends downward from the lower surface of the first base plate portion 44. The first peripheral wall portion 50 surrounds the first case attachment portion 46 and the two first board attachment portions 48. As shown in FIG. 6, when the first tray unit 30 is attached to the case body 4, a lower end of the first peripheral wall portion 50 is in contact with an upper end of the peripheral wall 22 of the case body 4. Due to this, the first peripheral wall portion 50, the peripheral wall 22, the first base plate portion 44, and an inner surface of the case body 4 define a board space 70. The two control boards 34 are disposed in the board space 70. The board space 70 is isolated from a space outside the board space 70. Also, a labyrinth structure is defined by a protrusion protruding from the upper end of the peripheral wall 22 fitting into a recess recessed from the lower end of the first peripheral wall portion 50. Due to this, even when the lid 6 (see FIG. 1) is open, liquid such as water can be suppressed from entering the board space 70. Due to this, the control boards 34 can be suppressed from touching the liquid. The case body 4 further has drain holes 72 penetrating a bottom of the case body 4, and the drain holes 72 are disposed outside the board space 70. Due to this, even when the liquid enters inside the case body 4, the liquid can be drained via the drain holes 72 to outside the case body 4.

As shown in FIG. 9, in the present embodiment, the at least one first battery attachment unit 52 comprises a plurality of (three) first battery attachment units 52. The three first battery attachment units 52 are aligned in a row in the left-right direction. The first battery attachment units 52 are disposed on an upper surface of the first base plate portion 44. The first battery attachment units 52 extend in the front-rear direction. The three first battery attachment units 52 have a substantially same shape. Each of the first battery attachment units 52 comprises a first base portion 76 and a plurality of (four in the present embodiment) first battery attachment portions 78.

The first base portion 76 extends upward from the upper surface of the first base plate portion 44. The first base portion 76 extends in the front-rear direction. As shown in FIG. 14, a position in the up-down direction of an upper end of the first base portion 76 is substantially the same as a position in the up-down direction of an upper end of the case body 4. Due to this, when the first tray unit 30 is attached to the case body 4, the first tray unit 30 does not protrude outside the case body 4. As shown in FIG. 9, the first base portion 76 has four first engagement grooves 80 recessed leftward from a right surface of the first base portion 76. The four first engagement grooves 80 are aligned in a row in the front-rear direction. The number of the four first engagement grooves 80 is the same as the number of the four first battery attachment portions 78.

The first battery attachment portions 78 are arranged on the right surface of the first base portion 76. The four first battery attachment portions 78 are aligned in a row in the front-rear direction. In each of the three first battery attachment units 52, the first battery attachment portions 78 are directed rightward. All of the plurality first battery attachment portions 78 are directed in the same orientation. Each of the first battery attachment portions 78 comprises a front battery attachment rail portion 82, a rear battery attachment rail portion 84, and a platform portion 86.

The front battery attachment rail portion 82 extends rightward from the right surface of the first base portion 76 and then bends to extend rearward. The front battery attachment rail portion 82 extends in the up-down direction. The rear battery attachment rail portion 84 extends rightward from the right surface of the first base portion 76 and then bends to extend frontward. The rear battery attachment rail portion 84 extends in the up-down direction. The first engagement groove 80 is disposed between the front battery attachment rail portion 82 and the rear battery attachment rail portion 84.

The platform portion 86 has a substantially cuboid shape. The platform portion 86 is arranged on the right surface of the first base portion 76. The platform portion 86 is disposed below the first engagement groove 80. The platform portion 86 is disposed between the front battery attachment rail portion 82 and the rear battery attachment rail portion 84.

Each of the first battery attachment portions 78 is configured to have a first battery pack BP1 (see FIG. 1) attached thereto. Further, because a width of each of second battery packs BP2 (see FIG. 2) is greater than a spacing between the first battery attachment units 52 that are adjacent in the left-right direction, the second battery packs BP2 are not configured to be attached to the first battery attachment portions 78.

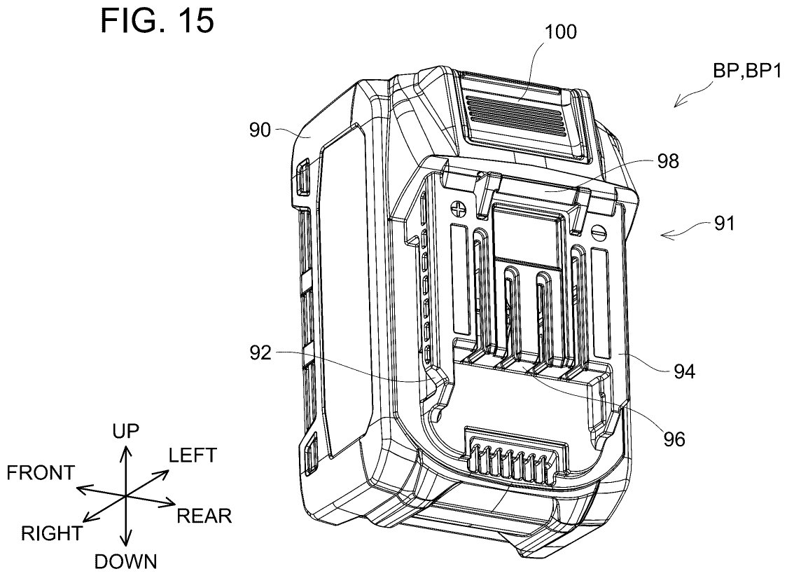

As shown in FIG. 15, each first battery pack BP1 comprises a first battery pack body 90 and an attachment structure 91 configured to be attached to one of the first battery attachment portions 78. The attachment structure 91 of the first battery pack BP1 comprises a front rail portion 92, a rear rail portion 94, a contact portion 96, and a hook portion 98. The front rail portion 92 projects leftward from the first battery pack body 90 and then bends to extend frontward. The rear rail portion 94 projects leftward from the first battery pack body 90 and then bends to extend rearward. The contact portion 96 is disposed between the front rail portion 92 and the rear rail portion 94. The hook portion 98 is normally biased by a spring (not illustrated) and projects outside the first battery pack body 90. The hook portion 98 enters inside the first battery pack body 90 in response to an operation portion 100 being pressed in.

When the first battery pack BP1 is attached to the first battery attachment portion 78 (see FIG. 9), the front rail portion 92 of the first battery pack BP1 is made to be engaged with the front battery attachment rail portion 82 of the first battery attachment portion 78 (see FIG. 9), and the rear rail portion 94 of the first battery pack BP1 is made to be engaged with the rear battery attachment rail portion 84 of the first battery attachment portion 78 (see FIG. 9). Next, the first battery pack BP1 is slid downward relative to the first battery attachment portion 78. At this occasion, the hook portion 98 has been pressed in by the first base portion 76 (see FIG. 9), and once the hook portion 98 has reached the first engagement groove 80, it projects from the first battery pack body 90. By the hook portion 98 entering the first engagement groove 80, the first battery pack BP1 can be suppressed from slipping out of the first battery attachment portion 78. When the first battery pack BP1 is detached from the first battery attachment portion 78, the operation portion 100 is pressed in so as to release the engagement between the hook portion 98 and the first engagement groove 80, and then the first battery pack BP1 is slid upward relative to the first battery attachment portion 78.

As shown in FIG. 9, one first battery terminal unit 54 is provided for one first battery attachment portion 78. The first battery terminal unit 54 is disposed between the front battery attachment rail portion 82 and the rear battery attachment rail portion 84. The first battery terminal unit 54 is disposed between the first engagement groove 80 and the platform portion 86. The first battery terminal unit 54 comprises a plurality of first battery terminals 104.

The first battery terminals 104 penetrate the right surface of the first base portion 76. The first battery terminals 104 are electrically connected to the first battery pack BP1 when the first battery pack BP1 is attached to the first battery attachment portion 78.

As shown in FIG. 14, each of the first battery terminal boards 56 is disposed within the first base portion 76. The first battery terminal boards 56 are supported by the first base portion 76. Since the labyrinth structure is defined at a boundary between the first lower base member 36 and the first upper base members 38, liquid such as water can be suppressed from entering inside the first base portion 76. Due to this, the liquid can be suppressed from touching the first battery terminal boards 56. In the present embodiment, one first battery terminal board 56 is provided for one first battery attachment portion 78. Due to this, the number of the plurality of first battery terminal boards 56 is the same as the number of the plurality of first battery attachment portions 78. Each of the first battery terminal boards 56 is arranged along a plane including the up-down direction and the front-rear direction. The plurality of first battery terminals 104 is directly mounted to the first battery terminal boards 56. The first battery terminal boards 56 are electrically connected to the control boards 34 (see FIG. 9). Power is supplied from the exterior power supply to the first battery packs BP1 via the exterior terminal 16 (see FIG. 3), the control boards 34, the first battery terminal boards 56, and the plurality of first battery terminals 104.

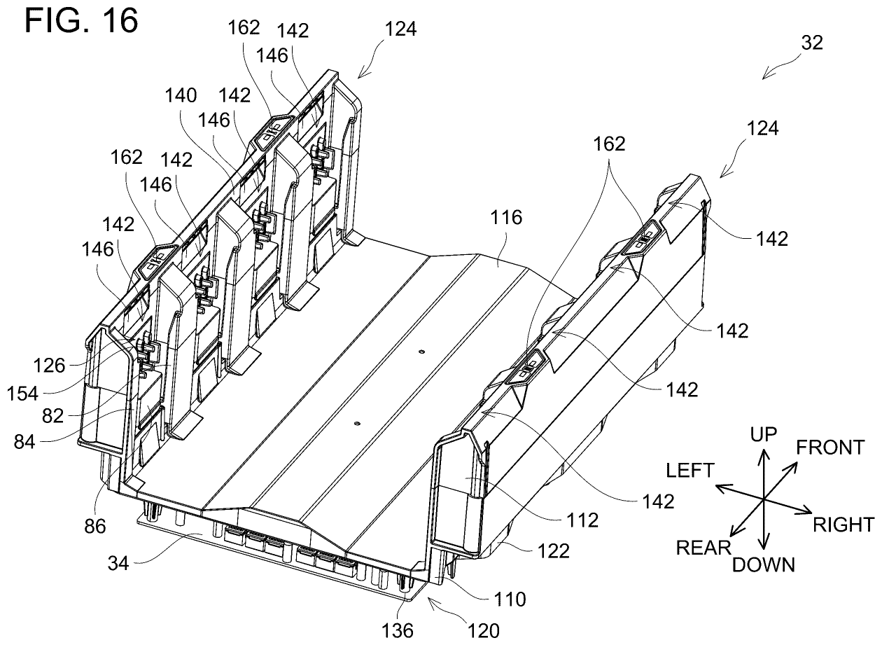

As shown in FIG. 16, the second tray unit 32 comprises a second lower base member 110 and a plurality of (two in the present embodiment) second upper base members 112. The second lower base member 110 and the plurality of second upper base members 112 define an exterior shape of the second tray unit 32. The plurality of second upper base members 112 is secured to the second lower base member 110. The plurality of second upper base members 112 are arranged side-by-side in the left-right direction.

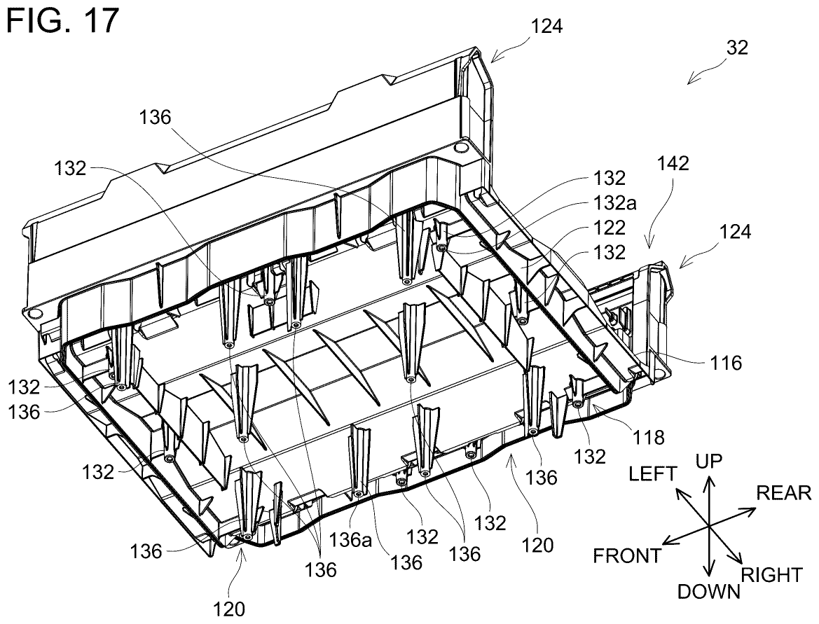

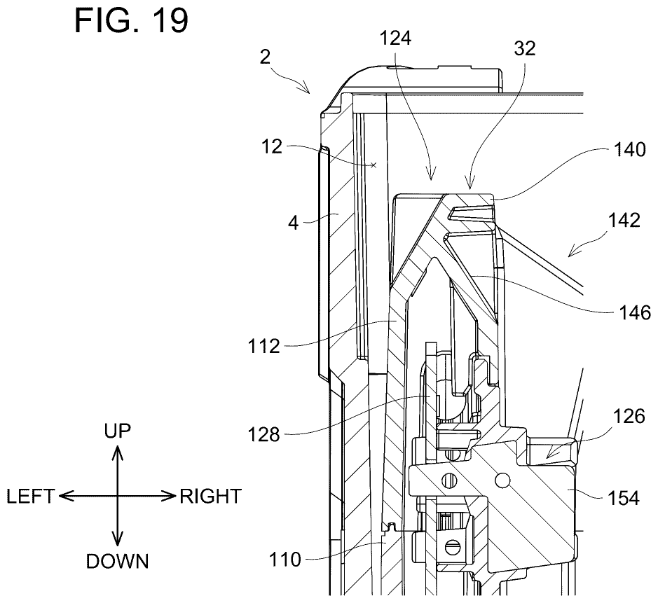

The second tray unit 32 comprises a second base plate portion 116, a second case attachment portion 118 (see FIG. 17), two second board attachment portions 120, a second peripheral wall portion 122 (see FIG. 17), at least one second battery attachment unit 124, a plurality of (eight in the present embodiment) second battery terminal units 126, and a plurality of (eight in the present embodiment) second battery terminal boards 128 (see FIG. 19). The second base plate portion 116, the second case attachment portion 118, the second board attachment portions 120, and the second peripheral wall portion 122 are configured by the second lower base member 110. The second battery attachment units 124 are configured by the second lower base member 110 and the second upper base members 112.

The second base plate portion 116 has a plate shape extending along the front-rear direction and the left-right direction. An area near a center of the second base plate portion 116 in the left-right direction is bulged upward.

As shown in FIG. 17, the second case attachment portion 118 comprises a plurality of (nine in the present embodiment) second attachment projections 132. The second attachment projections 132 extend downward from a lower surface of the second base plate portion 116. The number of the plurality of second attachment projections 132 is the same as each of the number of the plurality of projections 24 of the tray attachment portion 20 (see FIG. 5) and the number of the plurality of first case attachment projections 58 (see FIG. 11) in the first tray unit 30. As shown in FIG. 11, each of the second attachment projections 132 has a second hole 132a. Each of the second holes 132a has a thread formed therein. An arrangement of the second holes 132a of the plurality of second attachment projections 132 is the same as the arrangement of the plurality of first holes 58a of the first case attachment projections 58. Also, the second tray unit 32 is attached to the case body 4 by the fasteners 60 (see FIG. 12) that are used for attaching the first tray unit 30 to the tray attachment portion 20. As such, an attachment structure of the second case attachment portion 118 for attaching the tray attachment portion 20 is the same as an attachment structure of the first case attachment portion 46 for being attached to the tray attachment portion 20.

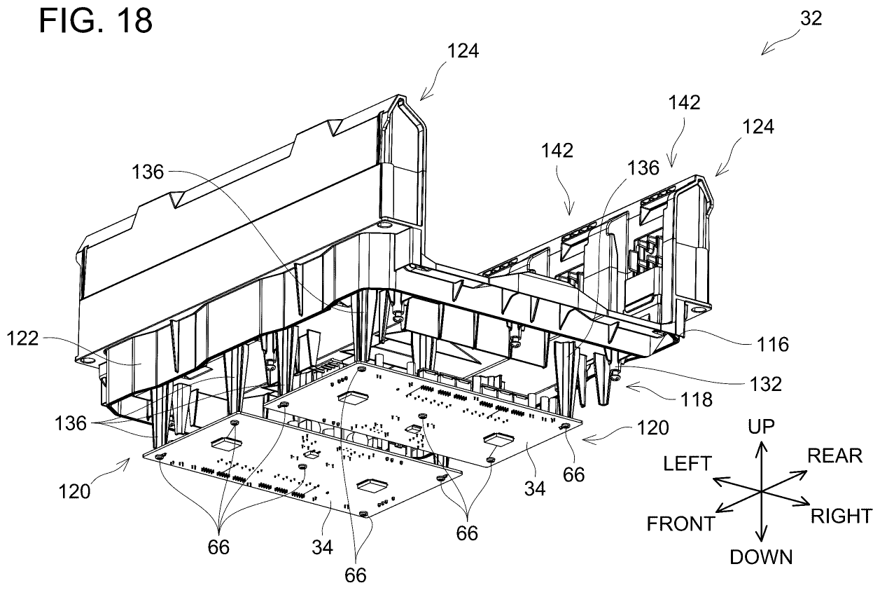

As shown in FIG. 17, the two second board attachment portions 120 are arranged side-by-side in the front-rear direction. Each of the second board attachment portions 120 comprises a plurality of (five in the present embodiment) second board attachment projections 136. The second board attachment projections 136 extend downward from the lower surface of the second base plate portion 116. As shown in FIG. 11, each of the second board attachment projections 136 has a second hole 136a. Each of the second holes 136a has a thread defined therein. An arrangement of the second holes 136a of the plurality of second board attachment projections 136 is the same as the arrangement of the first holes 64a of the plurality of first board attachment projections 64. As shown in FIG. 18, the control boards 34 are attached by the fasteners 66 being screwed with the second holes 136a (see FIG. 11). As such, an attachment structure of the second board attachment portions 120 for attaching the control boards 34 is the same as the attachment structure of the first board attachment portions 48 for attaching the control boards 34. Also, in the present embodiment, the common control boards 34 are configured to be attached selectively to one of the first board attachment portions 48 and the second board attachment portions 120. Further, one control board 34 is attached to one second board attachment portion 120. Due to this, the two control boards 34 are arranged side-by-side in the front-rear direction.

As shown in FIG. 17, the second peripheral wall portion 122 extends downward from the lower surface of the second base plate portion 116. When the second tray unit 32 is attached to the case body 4 (see FIG. 6), a lower end of the second peripheral wall portion 122 is in contact with the upper end of the peripheral wall 22 (see FIG. 6) of the case body 4. Due to this, in the second tray unit 32 also, the second peripheral wall portion 122, the peripheral wall 22, the second base plate portion 116, and the inner surface of the case body 4 define the board space 70 (see FIG. 6). The two control boards 34 are disposed in the board space 70. Further, a labyrinth structure is defined by a protrusion protruding from the upper end of the peripheral wall 22 fitting into a recess recessed from the lower end of the second peripheral wall portion 122. Due to this, the liquid such as water can be suppressed from entering the board space 70 and touching the control boards 34.

As shown in FIG. 16, in the present embodiment, the at least one second battery attachment unit 124 comprises a plurality of (two) the second battery attachment units 124. The two second battery attachment units 124 are aligned in a row in the left-right direction. The number two of the second battery attachment units 124 differs from the number three of the first battery attachment units 52 (see FIG. 9). The two second battery attachment units 124 have a substantially same shape. Each of the second battery attachment units 124 comprises a second base portion 140 and a plurality of (four in the present embodiment) second battery attachment portions 142.

The second base portion 140 extends upward from an upper surface of the second base plate portion 116. The second base portion 140 extends in the front-rear direction. As shown in FIG. 19, a position of an upper end of the second base portion 140 in the up-down direction is positioned below a position of an upper end of the case body 4 in the up-down direction. Due to this, when the second tray unit 32 is attached to the case body 4, the second tray unit 32 does not project outside the case body 4. As shown in FIG. 16, the second base portion 140 comprises four second engagement grooves 146 recessed from the second base portion 140. The four second engagement grooves 146 are aligned in a row in the front-rear direction. The number four of the second engagement grooves 146 is the same as the number four of the second battery attachment portions 142.

The second battery attachment portions 142 are disposed on side surfaces of the second base plate portion 116. The four second battery attachment portions 142 are aligned in a row in the front-rear direction. The number four of the second battery attachment portions 142 is the same as the number four of the first battery attachment portions 78 (see FIG. 9). A direction in which the four second battery attachment portions 142 of one of the second battery attachment units 124 are directed is different from a direction of the four second battery attachment portions 142 of another of the second battery attachment units 124. The four second battery attachment portions 142 of the one of the second battery attachment units 124 are directed rightward. The four second battery attachment portions 142 of the other of the second battery attachment units 124 are directed leftward, opposite from rightward. Due to this, the four second battery attachment portions 142 of the one of the second battery attachment units 124 face the four second battery attachment portions 142 of the other of the second battery attachment units 124. Also, an arrangement of the plurality of second battery attachment portions 142 in the second tray unit 32 is different from the arrangement of the plurality of first battery attachment portions 78 in the first tray unit 30.

Constituent features of the second battery attachment portions 142 are the same as constituent features of the first battery attachment portions 78. That is, each of the second battery attachment portions 142 comprises the front battery attachment rail portion 82, the rear battery attachment rail portion 84, and the platform portion 86. Also, a shape of the second battery attachment portions 142 is the same as the shape of the first battery attachment portions 78. As such, a detailed description for the configuration of the second battery attachment portions 142 will be omitted.

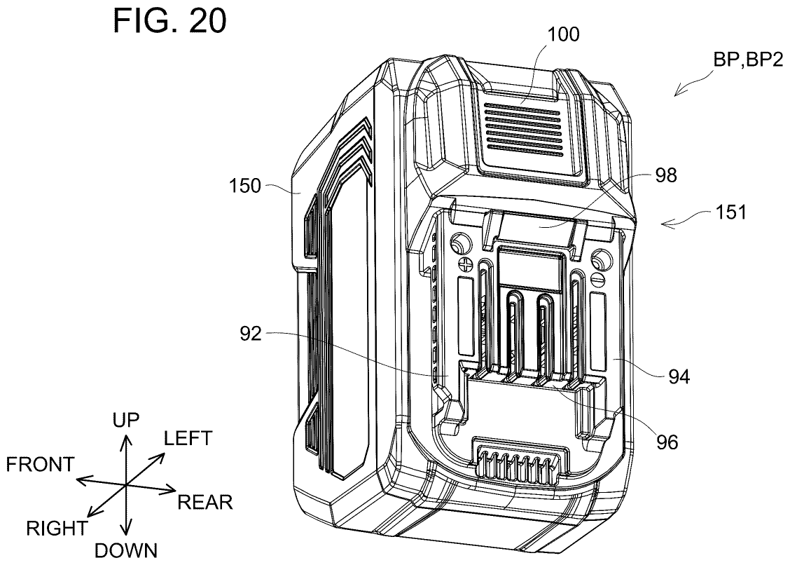

Each of the second battery attachment portions 142 is configured to have the second battery pack BP2 (see FIG. 2) attached thereto. Further, because the shape of the second battery attachment portions 142 is the same as the shape of the first battery attachment portions 78, the first battery pack BP1 can be attached to the second battery attachment portions 142. Due to this, an attachment structure of the second battery attachment portions 142 for attaching the second battery pack BP2 is the same as the attachment structure of the first battery attachment portions 78 for attaching the first battery pack BP1. As shown in FIG. 20, each of the second battery packs BP2 comprises a second battery pack body 150 and an attachment structure 151 configured to be attached to the second battery attachment portions 142, and the attachment structure 151 of the second battery pack BP2 is the same as the attachment structure 91 of the first battery pack BP1 (see FIG. 15). That is, the attachment structure 151 of the second battery pack BP2 comprises the front rail portion 92, the rear rail portion 94, the contact portion 96, and the hook portion 98.

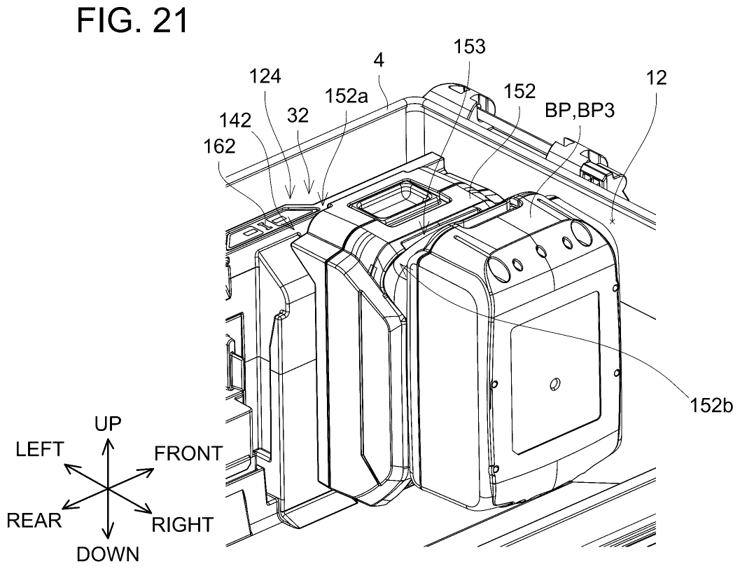

As shown in FIG. 21, each of the second battery attachment portions 142 is configured to have a third battery pack BP3 attached thereto via an adapter 152. The adapter 152 comprises a first adapter attachment portion 152a and a second adapter attachment portion 152b. A structure of the first adapter attachment portion 152a is the same as each of the attachment structure 91 of the first battery pack BP1 (see FIG. 15) and the attachment structure 151 of the second battery pack BP2 (see FIG. 20). As such, the adapter 152 is configured to be attached to the second battery attachment portions 142 via the first adapter attachment portion 152a. Also, an attachment structure 153 of the third battery pack BP3 is different from each of the attachment structure 91 of the first battery pack BP1 and the attachment structure 151 of the second battery pack BP2. As such, the third battery pack BP3 is not configured to be attached to the second battery attachment portions 142. On the other hand, the attachment structure 153 of the third battery pack BP3 has a shape corresponding to a structure of the second adapter attachment portion 152b of the adapter 152. As such, the third battery pack BP3 is configured to be attached to the adapter 152.

As shown in FIG. 16, one second battery terminal unit 126 is provided for one second battery attachment portion 142. An arrangement of the second battery terminal unit 126 relative to the second battery attachment portion 142 is the same as the arrangement of the first battery terminal unit 54 relative to the first battery attachment portion 78. Each of the second battery terminal units 126 comprises a plurality of second battery terminals 154.

The second battery terminals 154 protrude a side surface of the second base portion 140. The second battery terminals 154 are electrically connected to the second battery pack BP2 when the second battery pack BP2 is attached to the second battery attachment portion 142.

As shown in FIG. 19, the second battery terminal boards 128 are disposed inside the second base portion 140. The second battery terminal boards 128 are supported by the second base portion 140. Because a labyrinth structure is defined at a boundary between the second lower base member 110 and the second upper base members 112, liquid such as water can be suppressed from entering the second base portion 140. Due to this, the liquid can be suppressed from touching the second battery terminal boards 128. In the present embodiment, one second battery terminal board 128 is provided for one second battery attachment portion 142. Due to this, the number of the plurality of second battery terminal boards 128 is the same as the number of the plurality of second battery attachment portions 142. The second battery terminal boards 128 are positioned along a plane including the up-down direction and the front-rear direction. The plurality of second battery terminals 154 is directly mounted to the second battery terminal boards 128. The second battery terminal boards 128 are electrically connected to the control boards 34 (see FIG. 18). Power is supplied from the exterior power supply to the second battery packs BP2 via the exterior terminal 16 (see FIG. 3), the control boards 34, the second battery terminal boards 128, and the plurality of second battery terminals 154.

As shown in FIG. 9, the first tray unit 30 further comprises a plurality of (six in the present embodiment) first battery status indicators 160. Each of the first battery status indicators 160 displays a status of battery packs BP attached to the first battery attachment portions 78. The first battery status indicators 160 are arranged on the first base portions 76. In the present embodiment, one first battery status indicator 160 is arranged for two adjacent first battery attachment portions 78 in the front-rear direction.

As shown in FIG. 16, the second tray unit 32 further comprises a plurality of (four in the present embodiment) second battery status indicators 162. Each of the second battery status indicators 162 is configured to display a status of battery packs BP attached to the second battery attachment portions 142. The second battery status indicators 162 are arranged on the second base portions 140. In the present embodiment, one second battery status indicator 162 is arranged for two adjacent second battery attachment portions 142 in the front-rear direction. A configuration of the second battery status indicators 162 is the same as a configuration of the first battery status indicators 160.

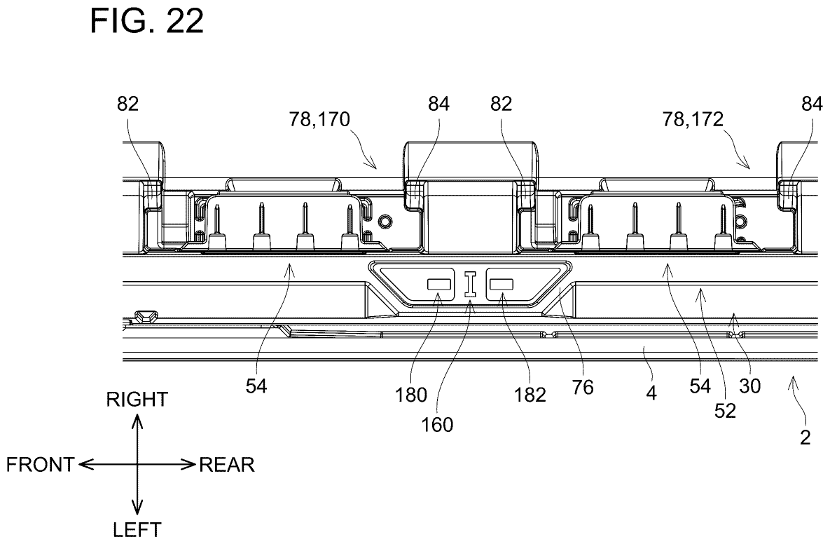

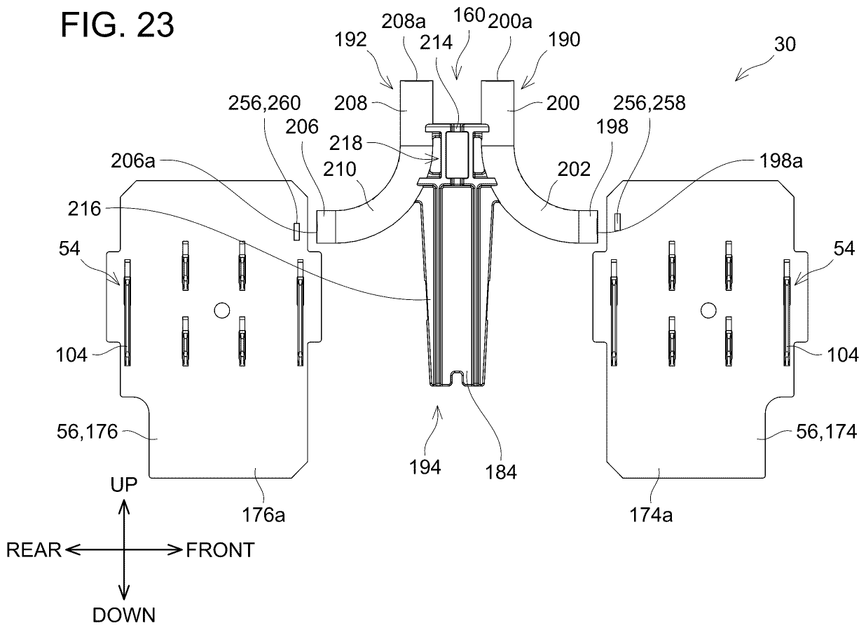

Hereafter, one of the first battery status indicators 160 will be described as an example. Also, as shown in FIG. 22, with respect to the two first battery attachment portions 78 adjacent in the front-rear direction, one of the two first battery attachment portions 78 will be referred to as a front battery attachment portion 170, whereas another of the two first battery attachment portions 78 will be referred to as a rear battery attachment portion 172. Also, as shown in FIG. 23, with respect to two first battery terminal boards 56 adjacent in the front-rear direction, one of the two first battery terminal boards 56 will be referred to as a front battery terminal board 174, whereas another of the two first battery terminal boards 56 will be referred to as a rear battery terminal board 176.

As shown in FIG. 22, each of the first battery status indicators 160 comprises a first indicator portion 180, a second indicator portion 182, and a lens 184 (see FIG. 23).

The first indicator portion 180 and the second indicator portion 182 are for example display windows. The first indicator portion 180 indicates the status of the battery pack BP attached to the front battery attachment portion 170. The second indicator portion 182 indicates the status of the battery pack BP attached to the rear battery attachment portion 172. The first indicator portion 180 and the second indicator portion 182 are disposed on the upper end of the first base portion 76. The first indicator portion 180 and the second indicator portion 182 are apart from each other in the front-rear direction. Both of the first indicator portion 180 and the second indicator portion 182 are offset from both of the front battery attachment portion 170 and the rear battery attachment portion 172 in the left-right direction. With respect to the front-rear direction, a center position between the first indicator portion 180 and the second indicator portion 182 is positioned between the front battery attachment portion 170 and the rear battery attachment portion 172. The center position between the first indicator portion 180 and the second indicator portion 182 in the front-rear direction corresponds to a center position of the first battery status indicator 160 in the front-rear direction.

As shown in FIG. 23, with respect to the front-rear direction, the lens 184 is disposed between the front battery terminal board 174 and the rear battery terminal board 176. The lens 184 faces each of a side surface of the front battery terminal board 174 and a side surface of the rear battery terminal board 176 in the front-rear direction. The lens 184 consists of one component. The lens 184 is constituted of a light transmissive material. The light transmissive material is for example polycarbonate, acrylic, polyamide, ABS. The lens 184 comprises a first transmissive portion 190, a second transmissive portion 192, and a connection portion 194.

The first transmissive portion 190 has a curved columnar shape. The first transmissive portion 190 is configured to transmit light. The first transmissive portion 190 comprises a first inlet 198, a first outlet 200, and a first curved portion 202.

The first inlet 198 extends in the front-rear direction. The first inlet 198 is directed frontward. The first inlet 198 comprises a first inlet surface 198a facing the front battery terminal board 174. The first inlet surface 198a is substantially perpendicular to the front-rear direction.

The first outlet 200 extends in the up-down direction. The first outlet 200 is directed upward. A direction in which the first outlet 200 is directed is inclined relative to a direction in which the first inlet 198 is directed. The direction in which the first outlet 200 is directed is substantially perpendicular to the direction in which the first inlet 198 is directed. The first outlet 200 comprises a first outlet surface 200a. The first outlet surface 200a is substantially perpendicular to the up-down direction.

The first curved portion 202 connects the first inlet 198 and the first outlet 200. The first curved portion 202 is curved.

The second transmissive portion 192 and the first transmissive portion 190 are disposed in symmetry with respect to a plane including the up-down direction and the left-right direction. A shape of the second transmissive portion 192 is the same as a shape of the first transmissive portion 190. The second transmissive portion 192 and the first transmissive portion 190 are apart from each other in the front-rear direction. The second transmissive portion 192 is configured to transmit light. The second transmissive portion 192 comprises a second inlet 206, a second outlet 208, and a second curved portion 210.

The second inlet 206 extends in the front-rear direction. The second inlet 206 is directed rearward. A direction in which the second inlet 206 is directed is opposite from the direction in which the first inlet 198 is directed. The second inlet 206 comprises a second inlet surface 206a facing the rear battery terminal board 176. The second inlet surface 206a is substantially perpendicular to the front-rear direction.

The second outlet 208 extends in the up-down direction. The second outlet 208 is directed upward. The direction in which the second outlet 208 is directed is inclined relative to the direction in which the second inlet 206 is directed. The direction in which the second outlet 208 is directed is substantially perpendicular to the direction in which the second inlet 206 is directed. The direction in which the second outlet 208 is directed is substantially the same as the direction in which the first outlet 200 is directed.

The second curved portion 210 connects the second inlet 206 and the second outlet 208. The second curved portion 210 is curved.

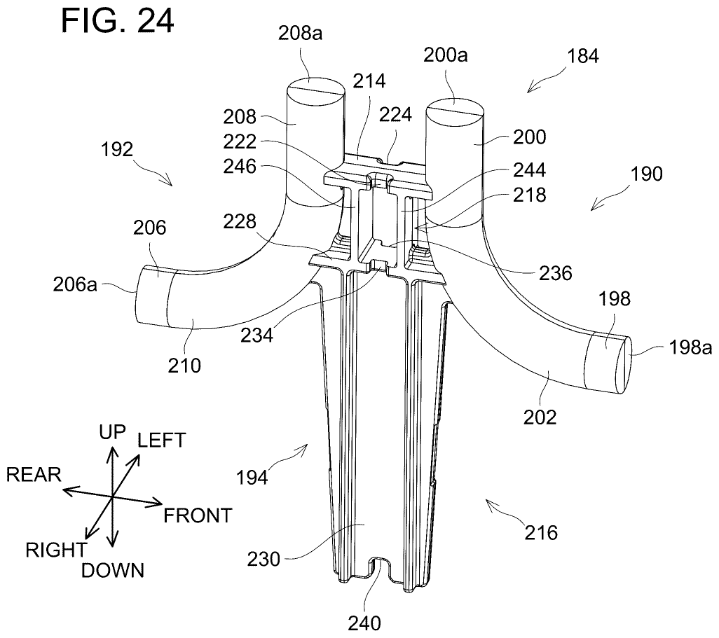

The connection portion 194 is disposed between the first transmissive portion 190 and the second transmissive portion 192. The connection portion 194 connects the first transmissive portion 190 and the second transmissive portion 192. As shown in FIG. 24, the connection portion 194 comprises a first connection portion 214, a second connection portion 216, and an intermediate connection portion 218.

The first connection portion 214 is disposed between the first outlet 200 and the second outlet 208. The first connection portion 214 connects the first outlet 200 and the second outlet 208. The first connection portion 214 extends in the front-rear direction.

The first connection portion 214 has a first right engagement portion 222 and a first left engagement portion 224. The first right engagement portion 222 and the first left engagement portion 224 are for example grooves. The first right engagement portion 222 is recessed leftward from a right end of the first connection portion 214. The first left engagement portion 224 is recessed rightward from a left end of the first connection portion 214. The first right engagement portion 222 and the first left engagement portion 224 are arranged side-by-side in the left-right direction.

The second connection portion 216 is apart from the first connection portion 214. The second connection portion 216 is disposed below the first connection portion 214. The second connection portion 216 comprises a second upper connection portion 228 and a second lower connection portion 230.

The second upper connection portion 228 is disposed between the first curved portion 202 and the second curved portion 210. The second upper connection portion 228 connects the first curved portion 202 and the second curved portion 210. The second upper connection portion 228 extends in the front-rear direction. The second upper connection portion 228 is substantially parallel to the first connection portion 214.

The second upper connection portion 228 has a second right engagement portion 234 and a second left engagement portion 236. The second right engagement portion 234 and the second left engagement portion 236 are for example grooves. The second right engagement portion 234 is recessed leftward from a right end of the second upper connection portion 228. The second right engagement portion 234 and the first right engagement portion 222 are arranged side-by-side in the up-down direction. The second left engagement portion 236 is recessed rightward from a left end of the second upper connection portion 228. The second left engagement portion 236 is arranged side-by-side with the first left engagement portion 224 in the up-down direction. The second right engagement portion 234 and the second left engagement portion 236 are arranged side-by-side in the left-right direction.

The second lower connection portion 230 extends downward from a lower end of the second upper connection portion 228. The second lower connection portion 230 has a second lower engagement portion 240. The second lower engagement portion 240 is for example a groove. The second lower engagement portion 240 is recessed downward from a lower end of the second lower connection portion 230.

The intermediate connection portion 218 is disposed between the first connection portion 214 and the second upper connection portion 228. The intermediate connection portion 218 is apart from both the first transmissive portion 190 and the second transmissive portion 192. The intermediate connection portion 218 comprises a first intermediate connection portion 244 and a second intermediate connection portion 246. The first right engagement portion 222, the first left engagement portion 224, the second right engagement portion 234, and the second left engagement portion 236 are disposed between the first intermediate connection portion 244 and the second intermediate connection portion 246.

The first intermediate connection portion 244 connects the first connection portion 214 and the second upper connection portion 228. The first intermediate connection portion 244 is apart from the first transmissive portion 190.

The second intermediate connection portion 246 connects the first connection portion 214 and the second upper connection portion 228. The second intermediate connection portion 246 is apart from the second transmissive portion 192. The second intermediate connection portion 246 is apart from the first intermediate connection portion 244.

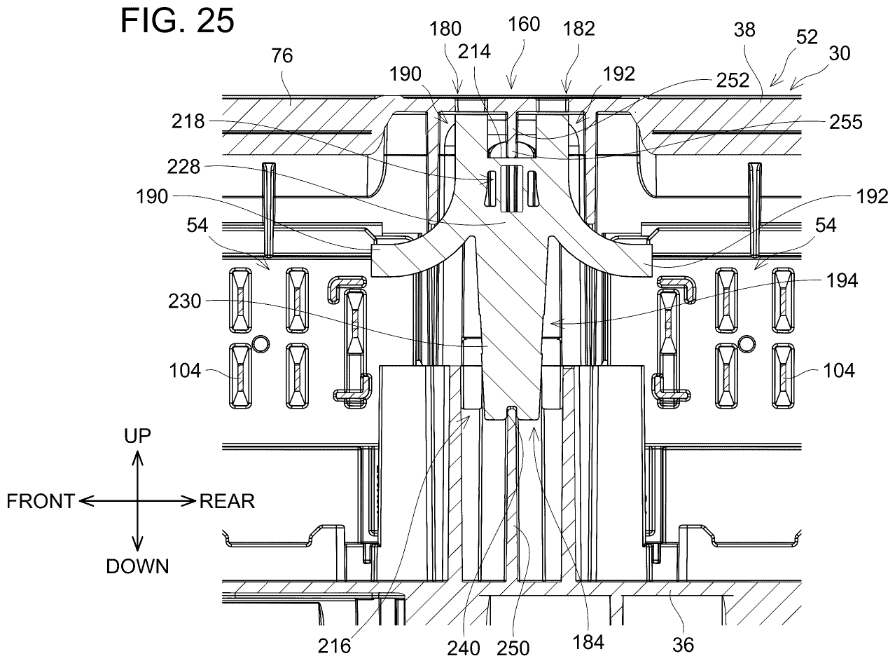

As shown in FIG. 25, the first base portion 76 comprises a first engagement rib 250 and a second engagement rib 252. The first engagement rib 250 and the second engagement rib 252 are disposed inside the first base portion 76. The first engagement rib 250 extends upward from an inner surface of the first base portion 76. The first engagement rib 250 engages with the second lower engagement portion 240. Due to this, the lens 184 can be suppressed from moving in the front-rear direction.

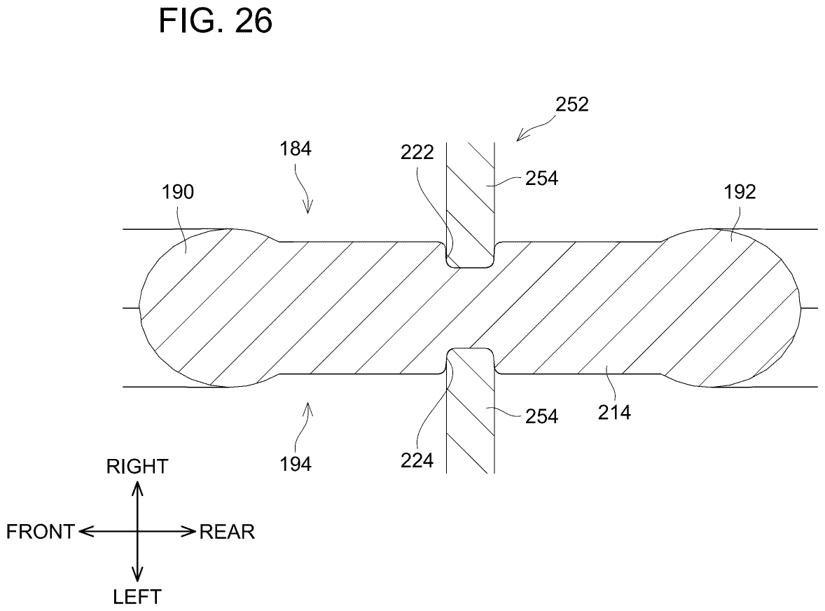

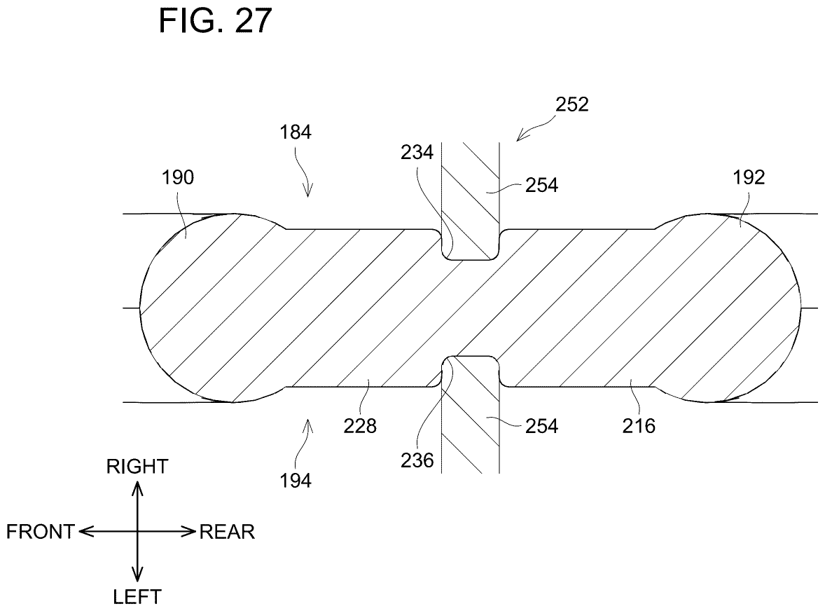

The second engagement rib 252 extends downward from the inner surface of the first base portion 76. The second engagement rib 252 comprises two leg portions 254 (see FIG. 26) and a leg connection portion 255 disposed between the two leg portions 254 and connecting the two leg portions 254. As shown in FIG. 26, the leg portions 254 are disposed between the first transmissive portion 190 and the second transmissive portion 192. Although not illustrated, the two leg portions 254 extend up to a spot below a lower end of the leg connection portion 255. As shown in FIG. 25, with respect to the up-down direction, the connection portion 194 is disposed between the leg connection portion 255 of the first engagement rib 250 and the second engagement rib 252. Due to this, the lens 184 can be suppressed from moving in the up-down direction. As shown in FIG. 26, the second engagement rib 252 engages with the first right engagement portion 222 and the first left engagement portion 224 by the two leg portions 254 sandwiching the first connection portion 214 in the first right engagement portion 222 and the first left engagement portion 224. As shown in FIG. 27, the second engagement rib 252 engages with the second right engagement portion 234 and the second left engagement portion 236 by the two leg portions 254 sandwiching the second upper connection portion 228 in the second right engagement portion 234 and the second left engagement portion 236. Due to this, the lens 184 can be suppressed from moving in the left-right direction.

As shown in FIG. 23, the first tray unit 30 comprises a plurality of (twelve in the present embodiment) light emitting devices 256. One light emitting device 256 is arranged for one first battery terminal board 56. Although not illustrated, the second tray unit 32 also comprises a plurality of (eight in the present embodiment) light emitting devices 256. One light emitting device 256 is arranged for one second battery terminal board 128. A configuration of the light emitting devices 256 in the first tray unit 30 is the same as a configuration of the light emitting devices 256 in the second tray unit 32. As such, hereafter the light emitting devices 256 in the first tray unit 30 will be described as an example. Further, the light emitting device 256 provided for the front battery terminal board 174 will be referred to as a front light emitting device 258, whereas the light emitting device 256 provided for the rear battery terminal board 176 will be referred to as a rear light emitting device 260.

The front light emitting device 258 is mounted on a mounting surface 174a of the front battery terminal board 174. The mounting surface 174a has the first battery terminals 104 mounted thereon. The mounting surface 174a extends along a plane including the front-rear direction and the up-down direction.

The rear light emitting device 260 is mounted on a mounting surface 176a of the rear battery terminal board 176. The mounting surface 176a has the first battery terminals 104 mounted thereon. The mounting surface 176a extends along a plane including the front-rear direction and the up-down direction. The mounting surface 176a is disposed on a same plane as the mounting surface 174a.

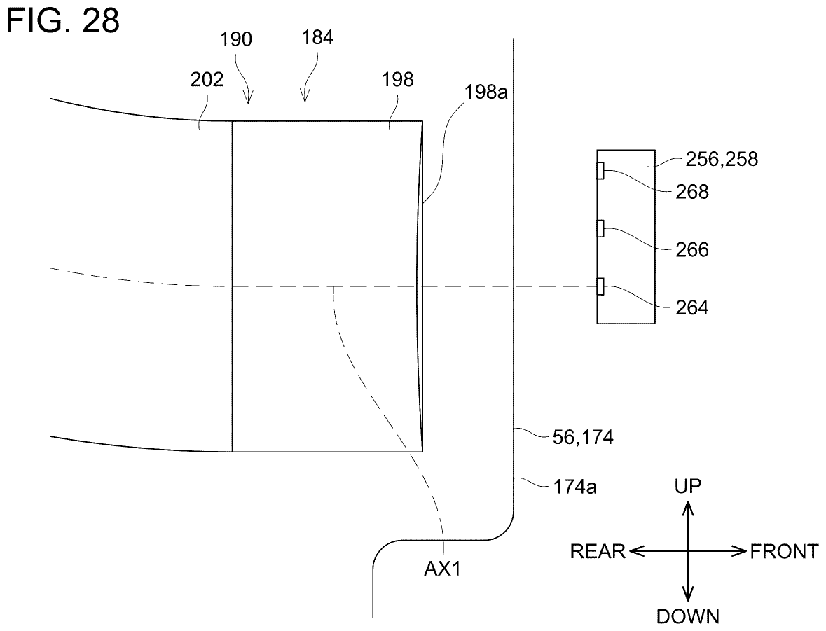

As shown in FIG. 28, the front light emitting device 258 comprises a blue light emitting portion 264, a red light emitting portion 266, and a green light emitting portion 268. The blue light emitting portion 264, the red light emitting portion 266, and the green light emitting portion 268 are aligned in a row in the up-down direction. The blue light emitting portion 264, the red light emitting portion 266, and the green light emitting portion 268 face the first inlet surface 198a of the first transmissive portion 190.

The blue light emitting portion 264 emits light in blue when the battery pack BP is being charged, for example. The red light emitting portion 266 emits light in red when, for example, an abnormality is occurring in the battery pack BP. The green light emitting portion 268 emits light in green when the charging of the battery pack BP is completed. The blue light emitting portion 264, the red light emitting portion 266, and the green light emitting portion 268 are directed rearward which is along the mounting surface 174a. Due to this, the light emitted by the blue light emitting portion 264, the red light emitting portion 266, and the green light emitting portion 268 travels rearward along the mounting surface 174a.

The blue light emitting portion 264 is disposed on an extension of a first central axis AX1 of the first transmissive portion 190. In FIG. 28, the first central axis AX1 and the extension of the first central axis AX1 are indicated with broken lines. The first central axis AX1 passes through a center of a circle of a cross section of the first inlet 198, a center of a circle of a cross section of the first outlet 200 (see FIG. 23), and a center of a circle of a cross section of the first curved portion 202.

The red light emitting portion 266 is disposed above the blue light emitting portion 264. The red light emitting portion 266 is disposed at a center position of the front light emitting device 258 in the up-down direction. The red light emitting portion 266 is offset upward from the extension of the first central axis AX1.

The green light emitting portion 268 is disposed above the red light emitting portion 266. The green light emitting portion 268 is offset upward from the extension of the first central axis AX1.

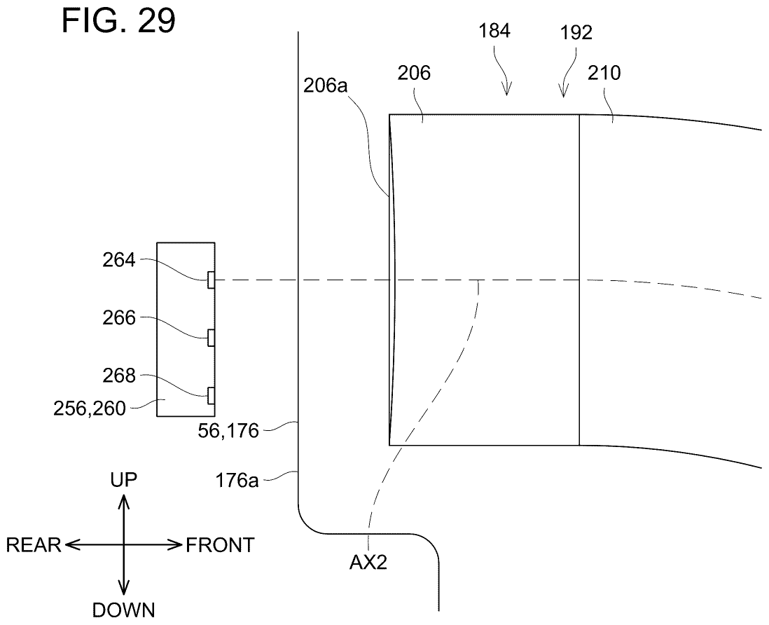

As shown in FIG. 29, a configuration of the rear light emitting device 260 is the same as the configuration of the front light emitting device 258. As such, the rear light emitting device 260 comprises the blue light emitting portion 264, the red light emitting portion 266, and the green light emitting portion 268. In the rear light emitting device 260, the blue light emitting portion 264, the red light emitting portion 266, and the green light emitting portion 268 are aligned in a row in the up-down direction, and face the second inlet surface 206a of the second transmissive portion 192. Also, in the rear light emitting device 260, the blue light emitting portion 264, the red light emitting portion 266, and the green light emitting portion 268 are directed frontward which is along the mounting surface 176a. Due to this, the light emitted by the blue light emitting portion 264, the red light emitting portion 266, and the green light emitting portion 268 travels frontward along the mounting surface 176a.

In the rear light emitting device 260, the blue light emitting portion 264 is disposed on an extension of the second central axis AX2 of the second transmissive portion 192. In FIG. 29, the second central axis AX2 and the extension of the second central axis AX2 are indicated with broken lines. The second central axis AX2 passes through a center of a circle of a cross section of the second inlet 206, a center of a circle of a cross section of the second outlet 208 (see FIG. 23), and a center of a circle of a cross section of the second curved portion 210.

In the rear light emitting device 260, the red light emitting portion 266 is disposed below the blue light emitting portion 264. The red light emitting portion 266 is disposed at a center position of the front light emitting device 258 in the up-down direction. The green light emitting portion 268 is disposed below the red light emitting portion 266. The red light emitting portion 266 and the green light emitting portion 268 are offset downward from the extension of the second central axis AX2.

As shown in FIG. 23, when the front light emitting device 258 emits light, the light enters the first transmissive portion 190 from the first inlet surface 198a of the first inlet 198. The light from the front light emitting device 258 passes sequentially through the first inlet 198, the first curved portion 202, and the first outlet 200, and exits the first transmissive portion 190 from the first outlet surface 200a of the first outlet 200 to outside. In the present embodiment, because the intermediate connection portion 218 is apart from each of the first transmissive portion 190 and the second transmissive portion 192, the light passing through the first transmissive portion 190 can be suppressed from entering the second transmissive portion 192 from the first transmissive portion 190. Further, since the two leg portions 254 are disposed between the first transmissive portion 190 and the second transmissive portion 192, the second engagement rib 252 can suppress the light passing through the first transmissive portion 190 from entering the second transmissive portion 192 from the first transmissive portion 190. The light exiting from the first outlet 200 passes through the first indicator portion 180 (see FIG. 22). Due to this, the light from the front light emitting device 258 is visually recognized by the user.

When the rear light emitting device 260 emits light, the light enters the second transmissive portion 192 from the second inlet surface 206a of the second inlet 206. The light from the rear light emitting device 260 passes sequentially through the second inlet 206, the second curved portion 210, and the second outlet 208, the light exits the second transmissive portion 192 from the second outlet surface 208a of the second outlet 208 to outside. In the present embodiment, because the intermediate connection portion 218 is apart from each of the first transmissive portion 190 and the second transmissive portion 192, the light passing through the second transmissive portion 192 can be suppressed from entering the first transmissive portion 190 from the second transmissive portion 192. Further, since the two leg portions 254 are disposed between the first transmissive portion 190 and the second transmissive portion 192, the second engagement rib 252 can suppress the light passing through the second transmissive portion 192 from entering the first transmissive portion 190 from the second transmissive portion 192. The light exiting from the second outlet 208 passes through the second indicator portion 182 (see FIG. 22). Due to this, the light from the rear light emitting device 260 is visually recognized by the user.

### Effects

The electrical apparatus 2 of the present embodiment comprises: the first tray unit 30, the second tray unit 32, and the case body 4 including the tray attachment portion 20 configured to have selectively one of the first tray unit 30 and the second tray unit 32 attached thereto. The first tray unit 30 comprises: the plurality of first attachment portions 78, each of which is configured to have the first battery pack BP1 (example for first battery) attached thereto; the first battery terminals 104 configured to be electrically connected to the first battery pack BP1 when the first battery pack BP1 is attached to one of the first battery attachment portions 78; and the first case attachment portion 46 configured to be attached to the tray attachment portion 20. The second tray unit 32 comprises: the plurality of second battery attachment portions 142, each of which is configured to have the second battery pack BP2 (example for second battery) attached thereto; the second battery terminals 154 configured to be electrically connected to the second battery pack BP2 when the second battery pack BP2 is attached to one of the second battery attachment portions 142; and the second case attachment portion 118 configured to be attached to the tray attachment portion 20. The arrangement of the plurality of second battery attachment portions 142 is different from the arrangement of the plurality of first battery attachment portions 78, and/or the number of the plurality of second battery attachment portions 142 is different from the number of the plurality of first battery attachment portions 78, and/or the attachment structure of each of the second battery attachment portions 142 for attaching the second battery pack BP2 is different from the attachment structure of each of the first battery attachment portions 78 for attaching the first battery pack BP1.

According to the above configuration, the first battery pack BP1 can be attached to one of the first battery attachment portions 78 in the first tray unit 30. Also, the second battery pack BP2 can be attached to one of the second battery attachment portions 142 of the second tray unit 32. Due to this, by switching between the first tray unit 30 and the second tray unit 32, both the first battery pack BP1 and the second battery pack BP2 can be used in a single electrical apparatus 2. Due to this, user convenience can be improved.

The attachment structure of the first case attachment portion 46 for being attached to the tray attachment portion 20 is the same as the attachment structure of the second case attachment portion 118 for being attached to the tray attachment portion 20.

According to the above configuration, the structure of the tray attachment portion 20 can be suppressed from becoming complicated as compared to a configuration in which the attachment structure of the first case attachment portion 46 for being attached to the tray attachment portion 20 is different from the attachment structure of the second case attachment portion 118 for being attached to the tray attachment portion 20.

The attachment structure of each of the first battery attachment portions 78 for attaching the first battery pack BP1 is the same as the attachment structure of each of the second battery attachment portions 142 for attaching the second battery pack BP2.

According to the above configuration, the first battery pack BP1 can be attached to one of the second battery attachment portions 142 and the second battery pack BP2 can be attached to one of the first battery attachment portions 78. Due to this, user convenience can be improved.

The electrical apparatus 2 further comprises the control boards 34 configured to be attached to the first tray unit 30.

According to the above configuration, after the control boards 34 are attached to the first tray unit 30, the first tray unit 30 can be attached to the case body 4. Due to this, assembly of the electrical apparatus can be facilitated.

The control boards 34 are also configured to be attached to the second tray unit 32.

According to the above configuration, a control board dedicated for the second tray unit 32 is unnecessary. Due to this, the number of parts in the electrical apparatus 2 can be reduced.

The first tray unit 30 is attached to the tray attachment portion 20 by the fasteners 60. The fasteners 60 are attached to the first tray unit 30 from outside of the case body 4.

According to the above configuration, the first tray unit 30 is attached to the tray attachment portion 20 by the fasteners 60 being inserted into the case body 4 from outside the case body 4. Due to this, assembly of the electrical apparatus 2 can be facilitated.

The case body 4 comprises the accommodating space 12 configured to accommodate the first tray unit 30 and the second tray unit 32.

According to the above configuration, the first and second tray units 30 and 32 are protected by the case body 4, and thus the first tray unit 30 and the second tray unit 32 can be suppressed from being damaged/broken.

The first tray unit 30 comprises the at least one first battery attachment unit 52. Each of the at least one first battery attachment unit 52 comprises two or more first battery attachment portions 78. The second tray unit 32 comprises at least one second battery attachment unit 124. Each of the at least one second battery attachment unit 124 comprises two or more second battery attachment portions 142. The number of the two or more second battery attachment portions 142 is the same as the number of the two or more first battery attachment portions 78. The number of the at least one second battery attachment unit 124 is different from the number of the at least one first battery attachment unit 52.

According to the above configuration, the first tray unit 30 and the second tray unit 32 can be selectively used according to the number of batteries used.

The at least one first battery attachment unit 52 comprises the plurality of the first battery attachment units 52 aligned in a row. The at least one second battery attachment unit 124 comprises the plurality of the second battery attachment units 124 aligned in a row. In two first battery attachment units 52 adjacent to each other, the two or more first battery attachment portions 78 in each of the two first battery attachment units 52 are directed in the same direction. In two second battery attachment units 124 adjacent to each other, the direction in which the two or more second battery attachment portions 142 in one of the two second battery attachment units 124 are directed is different from the direction in which the two or more second battery attachment portions 142 in the other of the two second battery attachment units 124 are directed.

According to the above configuration, the first tray unit 30 and the second tray unit 32 can be selectively used according to the number and/or size of batteries used.

The first tray unit 30 further comprises the first battery status indicators 160 (example for first indicator) configured to indicate the status of the first battery pack BP1.

According to the above configuration, the status of the first battery pack BP1 can be easily acknowledged.

The plurality of first battery attachment portions 78 is aligned in the front-rear direction (example for a first direction). With respect to the front-rear direction, the position of the center of each of the first battery status indicators 160 in the front-rear direction is located between two first battery attachment portions 78 adjacent to each other in the front-rear direction.

According to the above configuration, each of the first battery status indicators 160 can be easily positioned relative to the two first battery attachment portions 78.

### Second Embodiment

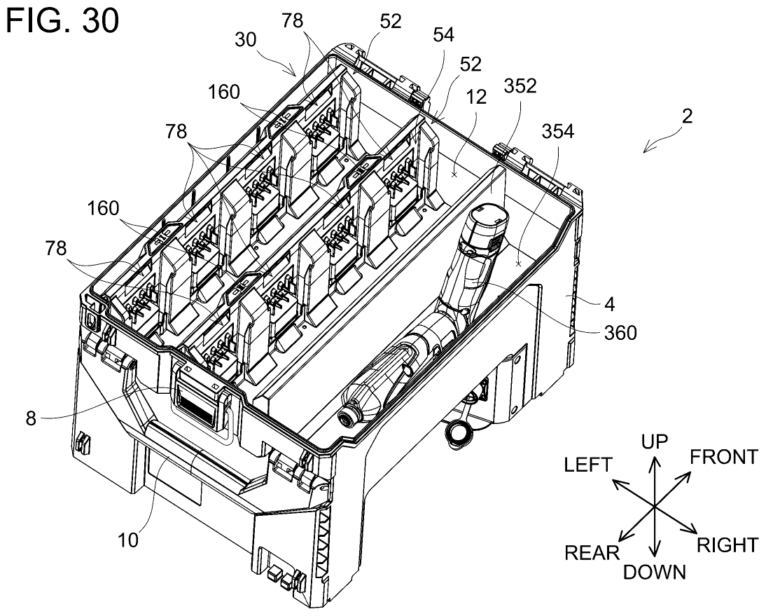

In a second embodiment, points different from the first embodiment will only be described. As shown in FIG. 30, the number of the at least one first battery attachment unit 52 in the second embodiment (i.e., two) is less than the number of the at least one first battery attachment unit 52 (i.e., three) in the first embodiment. Also, an arrangement of the plurality of first battery attachment portions 78 in the first tray unit 30 is different from an arrangement of the plurality of second battery attachment portions 142 (see FIG. 7) in the second tray unit 32.

In the second embodiment, the first tray unit 30 further comprises a bulkhead wall 352. The bulkhead wall 352 extends upward from the upper surface of the first base plate portion 44. The bulkhead wall 352 extends in the front-rear direction. The bulkhead wall 352 is apart from an inner side surface of the case body 4. Due to this, a tool accommodating space 354 is defined between the bulkhead wall 352 and the inner side surface of the case body 4. A tool 360 such as an impact driver is placed in the tool accommodating space 354. The tool 360 may be configured to operate on power of the battery packs BP, or may be configured to operate on power of another type of battery pack. Both of the tool 360 and the battery packs BP (see FIG. 1) can be accommodated in the electrical apparatus 2.

### Effects

The electrical apparatus 2 of the present embodiment is a case. The electrical apparatus 2 comprises the first tray unit 30, the second tray unit 32, and the case body 4 including the tray attachment portion 20 configured to have selectively one of the first tray unit 30 and the second tray unit 32 attached thereto. The first tray unit 30 comprises the plurality of first battery attachment portions 78, each of which is configured to have the first battery pack BP1 (example for first battery) attached thereto and the first case attachment portion 46 configured to be attached to the tray attachment portion 20. The second tray unit 32 comprises the plurality of second battery attachment portions 142, each of which is configured to have the second battery pack BP2 (example for a second battery) attached thereto and the second case attachment portion 118 configured to be attached to the tray attachment portion 20. The case body 4 is configured to accommodate the first battery pack BP1 and the second battery pack BP2. The arrangement of the plurality of second battery attachment portions 142 is different from the arrangement of the plurality of first battery attachment portions 78, and/or the number of the plurality of second battery attachment portions 142 is different from the number of the plurality of first battery attachment portions 78, and/or the attachment structure of each of the second battery attachment portions 142 for attaching the second battery pack BP2 is different from the attachment structure of each of the first battery attachment portions 78 for attaching the first battery pack BP1.

According to the above configuration, the first battery pack BP1 can be attached to one of the first battery attachment portions 78 in the first tray unit 30. Also, the second battery pack BP2 can be attached to one of the second battery attachment portions 142 in the second tray unit 32. Due to this, by switching between the first tray unit 30 and the second tray unit 32, both of the first battery pack BP1 and the second battery pack BP2 can be used in the single electrical apparatus 2. Due to this, user convenience can be improved.

The attachment structure of the first case attachment portion 46 for being attached to the tray attachment portion 20 is the same as the attachment structure of the second case attachment portion 118 for being attached to the tray attachment portion 20.

According to the above configuration, the structure of the tray attachment portion 20 can be suppressed from becoming complicated as compared to the configuration in which the attachment structure of the first case attachment portion 46 for being attached to the tray attachment portion 20 is different from the attachment structure of the second case attachment portion 118 for being attached to the tray attachment portion 20.

The attachment structure of each of the first battery attachment portions 78 for attaching the first battery pack BP1 is the same as the attachment structure of each of the second battery attachment portions 142 for attaching the second battery pack BP2.

According to the above configuration, the first battery pack BP1 can be attached to one of the second battery attachment portions 142 and the second battery pack BP2 can be attached to one of the first battery attachment portions 78. Due to this, user convenience can be improved.

The electrical apparatus 2 is configured to accommodate the tool 360.

According to the above configuration, the first battery pack BP1, the second battery pack BP2, and the tool 360 are accommodated in the case, user convenience can be further improved.

### Third Embodiment

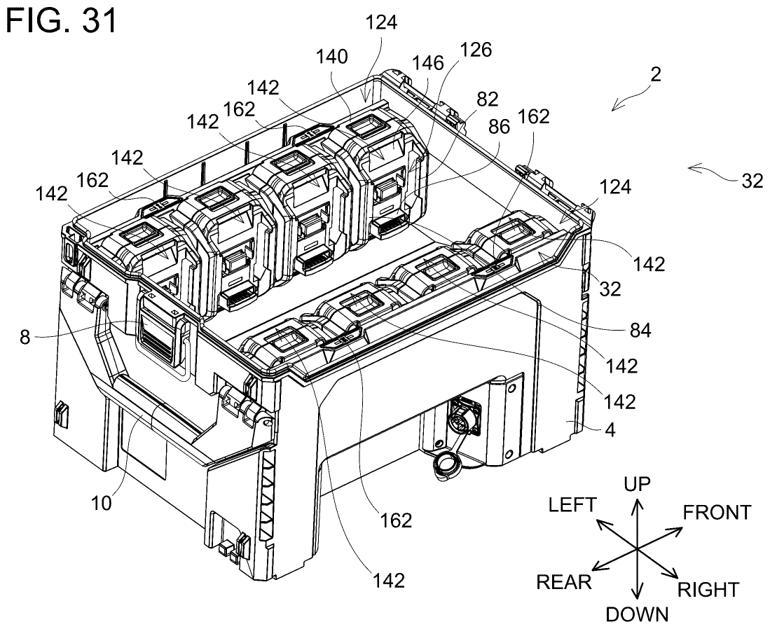

In a third embodiment, points different from the first embodiment will only be described. As shown in FIG. 31, a configuration of the second battery attachment portions 142 in the second tray unit 32 in the third embodiment is different from a configuration of the second battery attachment portions 142 in the second tray unit 32 in the first embodiment.

A shape of the second battery attachment portions 142 is the same as the shape of the second adapter attachment portion 152b of the adapter 152 in the first embodiment. Due to this, an attachment structure of the second battery attachment portions 142 for attaching the battery pack BP is the same as the attachment structure of the second adapter attachment portion 152b for attaching the battery pack BP. Due to this, the first battery pack BP1 (see FIG. 15) and the second battery pack BP2 (see FIG. 20) cannot be attached to each of the second battery attachment portions 142. Contrary to this, the third battery pack BP3 (see FIG. 21) can be attached to each of the second battery attachment portions 142. As such, the attachment structure of the second battery attachment portions 142 for attaching the third battery pack BP3 is different from the attachment structure of the first battery attachment portions 78 in the first tray unit 30 for attaching the first battery pack BP1.

### Modifications

In the electrical apparatus 2 according to an aspect, each of the first battery status indicators 160 and the second battery status indicators 162 may comprise only one of the first indicator portion 180 and the second indicator portion 182. In this configuration, the first indicator portion 180 displays both of the light emitted by the front light emitting device 258 and the light emitted by the rear light emitting device 260.

In an aspect, the center of each of the first battery status indicators 160 in the front-rear direction may not be located between the front battery attachment portion 170 and the rear battery attachment portion 172.

In an aspect, a direction in which the first inlet 198 of the first transmissive portion 190 is directed may not be opposite from the direction in which the second inlet 206 of the second transmissive portion 192 is directed.

In an aspect, one first battery terminal board 56 may be provided for a plurality of first battery attachment portions 78. Further, one second battery terminal board 128 may be provided for a plurality of second battery attachment portions 142.

In an aspect, only one control board 34 may be attached to the first tray unit 30 and may be attached to the second tray unit 32.

In an aspect, the electrical apparatus 2 may comprise a first control board attached to the first tray unit 30 and a second control board attached to the second tray unit 32.

The configuration for attaching the first tray unit 30 and the second tray unit 32 to the case body 4 may not be limited to the fasteners 60, but may be a snap-fit configuration.

In an aspect, the first tray unit 30 may not comprise the first battery terminal units 54 and the first battery terminal boards 56. The second tray unit 32 may not comprise the second battery terminal units 126 and the second battery terminal boards 128.

In an aspect, one of the number of the at least one first battery attachment unit 52 and the number of the at least one second battery attachment unit 124 may be one.

In an aspect, in the two adjacent second battery attachment units 124, the four second battery attachment portions 142 of one of the second battery attachment units 124 may be directed leftward, whereas the four second battery attachment portions 142 of the other of the second battery attachment units 124 may be directed rightward. Due to this, a back surface of the second base portion 140 of one of the second battery attachment units 124 faces a back surface of the second base portion 140 of the other of the second battery attachment units 124. Further, the direction in which the four second battery attachment portions 142 of one of the second battery attachment units 124 may be inclined by a first angle relative to the direction in which the four second battery attachment portions 142 of the other of the second battery attachment units 124. The first angle may be more than 0 degrees and may be smaller than 180 degrees.

What is claimed is:

1. An electrical apparatus comprising:
a first tray unit;
a second tray unit; and
a case body including a tray attachment portion configured to have selectively one of the first tray unit and the second tray unit attached thereto,
wherein the first tray unit comprises:
a plurality of first battery attachment portions, each of which is configured to have a first battery attached thereto;
a first battery terminal configured to be electrically connected to the first battery when the first battery is attached to one of the first battery attachment portions; and
a first case attachment portion configured to be attached to the tray attachment portion,
the second tray unit comprises:
a plurality of second battery attachment portions, each of which is configured to have a second battery attached thereto;
a second battery terminal configured to be electrically connected to the second battery when the second battery is attached to one of the second battery attachment portions; and
a second case attachment portion configured to be attached to the tray attachment portion, and
an arrangement of the plurality of second battery attachment portions is different from an arrangement of the plurality of first battery attachment portions, and/or a number of the plurality of second battery attachment portions is different from a number of the plurality of first battery attachment portions, and/or an attachment structure of each of the second battery attachment portions for attaching the second battery is different from an attachment structure of each of the first battery attachment portions for attaching the first battery.

2. The electrical apparatus according to claim 1, wherein an attachment structure of the first case attachment portion for being attached to the tray attachment portion is the same as an attachment structure of the second case attachment portion for being attached to the tray attachment portion.

3. The electrical apparatus according to claim 1, wherein the attachment structure of each of the first battery attachment portions for attaching the first battery is the same as the attachment structure of each of the second battery attachment portions for attaching the second battery.

4. The electrical apparatus according to claim 1, further comprising a control board attached to the first tray unit.

5. The electrical apparatus according to claim 4, wherein the control board is configured to be attached to the second tray unit.

6. The electrical apparatus according to claim 1, wherein the first tray unit is attached to the tray attachment portion by a fastener, and
the fastener is attached to the first tray unit from outside of the case body.

7. The electrical apparatus according to claim 1, wherein the case body comprises an accommodating space configured to accommodate the first tray unit and the second tray unit.

8. The electrical apparatus according to claim 1, wherein the first tray unit comprises at least one first battery attachment unit,
each of the at least one first battery attachment unit comprises two or more first battery attachment portions,
the second tray unit comprises at least one second battery attachment unit,
each of the at least one second battery attachment unit comprises two or more second battery attachment portions,
a number of the two or more second battery attachment portions is the same as a number of the two or more first battery attachment portions, and
a number of the at least one second battery attachment unit is different from a number of the at least one first battery attachment unit.

9. The electrical apparatus according to claim 8, wherein the at least one first battery attachment unit comprises a plurality of the first battery attachment units aligned in a row,
the at least one second battery attachment unit comprises a plurality of the second battery attachment units aligned in a row,
in two first battery attachment units adjacent to each other, the two or more first battery attachment portions in each of the two first battery attachment units are directed in the same direction, and
in two second battery attachment units adjacent to each other, a direction in which the two or more second battery attachment portions in one of the two second battery attachment units are directed is different from a direction in which the two or more second battery attachment portions in the other of the two second battery attachment units are directed.

10. The electrical apparatus according to claim 1, wherein the first tray unit comprises a first indicator configured to indicate a status of the first battery.

11. The electrical apparatus according to claim 10, wherein the plurality of first battery attachment portions is aligned in a first direction, and
with respect to the first direction, a position of a center of the first indicator in the first direction is located between two first battery attachment portions adjacent to each other in the first direction.

12. A case, comprising:
a first tray unit;
a second tray unit; and
a case body including a tray attachment portion configured to have selectively one of the first tray unit and the second tray unit attached thereto,
wherein the first tray unit comprises:
a plurality of first battery attachment portions, each of which is configured to have a first battery attached thereto; and
a first case attachment portion configured to be attached to the tray attachment portion,
the second tray unit comprises:
a plurality of second battery attachment portions, each of which is configured to have a second battery attached thereto; and
a second case attachment portion configured to be attached to the tray attachment portion,
the case body is configured to accommodate the first battery and the second battery, and
an arrangement of the plurality of second battery attachment portions is different from an arrangement of the plurality of first battery attachment portions, and/or a number of the plurality of second battery attachment portions is different from a number of the plurality of first battery attachment portions, and/or an attachment structure of each of the second battery attachment portions for attaching the second battery is different from an attachment structure of each of the first battery attachment portions for attaching the first battery.

13. The case according to claim 12, wherein an attachment structure of the first case attachment portion for being attached to the tray attachment portion is the same as an attachment structure of the second case attachment portion for being attached to the tray attachment portion.

14. The case according to claim 12, wherein the attachment structure of each of the first battery attachment portions for attaching the first battery is the same as the attachment structure of each of the second battery attachment portions for attaching the second battery.

15. The case according to claim 12, wherein the case is configured to accommodate a tool.

16. The electrical apparatus according to claim 2, wherein
the attachment structure of each of the first battery attachment portions for attaching the first battery is the same as the attachment structure of each of the second battery attachment portions for attaching the second battery,
the electrical apparatus further comprises a control board attached to the first tray unit,
the control board is configured to be attached to the second tray unit,
the first tray unit is attached to the tray attachment portion by a fastener,
the fastener is attached to the first tray unit from outside of the case body,
the case body comprises an accommodating space configured to accommodate the first tray unit and the second tray unit,
the first tray unit comprises at least one first battery attachment unit,
each of the at least one first battery attachment unit comprises two or more first battery attachment portions,
the second tray unit comprises at least one second battery attachment unit,
each of the at least one second battery attachment unit comprises two or more second battery attachment portions,
a number of the two or more second battery attachment portions is the same as a number of the two or more first battery attachment portions,
a number of the at least one second battery attachment unit is different from a number of the at least one first battery attachment unit,
the at least one first battery attachment unit comprises a plurality of the first battery attachment units aligned in a row,
the at least one second battery attachment unit comprises a plurality of the second battery attachment units aligned in a row,
in two first battery attachment units adjacent to each other, the two or more first battery attachment portions in each of the two first battery attachment units are directed in the same direction,
in two second battery attachment units adjacent to each other, a direction in which the two or more second battery attachment portions in one of the two second battery attachment units are directed is different from a direction in which the two or more second battery attachment portions in the other of the two second battery attachment units are directed,
the first tray unit comprises a first indicator configured to indicate a status of the first battery,
the plurality of first battery attachment portions is aligned in a first direction, and
with respect to the first direction, a position of a center of the first indicator in the first direction is located between two first battery attachment portions adjacent to each other in the first direction.

17. The case according to claim 13, wherein
the attachment structure of each of the first battery attachment portions for attaching the first battery is the same as the attachment structure of each of the second battery attachment portions for attaching the second battery,
the case is configured to accommodate a tool,
the case further comprises a control board attached to the first tray unit,
the control board is configured to be attached to the second tray unit,
the first tray unit is attached to the tray attachment portion by a fastener,
the fastener is attached to the first tray unit from outside of the case body,
the case body comprises an accommodating space configured to accommodate the first tray unit and the second tray unit,
the first tray unit comprises at least one first battery attachment unit,
each of the at least one first battery attachment unit comprises two or more first battery attachment portions,
the second tray unit comprises at least one second battery attachment unit,
each of the at least one second battery attachment unit comprises two or more second battery attachment portions,
a number of the two or more second battery attachment portions is the same as a number of the two or more first battery attachment portions,
a number of the at least one second battery attachment unit is different from a number of the at least one first battery attachment unit,
the at least one first battery attachment unit comprises a plurality of the first battery attachment units aligned in a row,
the at least one second battery attachment unit comprises a plurality of the second battery attachment units aligned in a row,
in two first battery attachment units adjacent to each other, the two or more first battery attachment portions in each of the two first battery attachment units are directed in the same direction,
in two second battery attachment units adjacent to each other, a direction in which the two or more second battery attachment portions in one of the two second battery attachment units are directed is different from a direction in which the two or more second battery attachment portions in the other of the two second battery attachment units are directed,
the first tray unit comprises a first indicator configured to indicate a status of the first battery,
the plurality of first battery attachment portions is aligned in a first direction, and
with respect to the first direction, a position of a center of the first indicator in the first direction is located between two first battery attachment portions adjacent to each other in the first direction.
